(19) United States
(12) Patent Application Publication
(10) Pub. No.: US 2025/0276708 A1
(43) Pub. Date: Sep. 4, 2025

(54) SYSTEM AND METHOD FOR OPTIMIZATION OF VEHICLE PERCEPTION SENSOR CONFIGURATION

(71) Applicant: Toyota Motor Engineering & Manufacturing North America, Inc., Plano, TX (US)

(72) Inventors: Noah T. Curran, Ann Arbor, MI (US); Georgios Fainekos, Novi, MI (US); Bardh Hoxha, Canton, MI (US); Hideki Okamoto, Ann Arbor, MI (US); Danil V. Prokhorov, Canton, MI (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/593,630

(22) Filed: Mar. 1, 2024

(51) Int. Cl. B60W 50/14; B60W 60/00

(52) U.S. Cl. CPC B60W 50/14; B60W 60/0015; B60W 2050/146; B60W 2540/215; B60W 2554/80

(57) ABSTRACT

A method, computer-readable media, and computer system for receiving perception sensor input data of an autonomous vehicle, the perception sensor input data corresponding to respective measured location, orientation, and type of each of a plurality of perception sensors of the autonomous vehicle; receiving ground-truth information input data of the autonomous vehicle, the ground-truth information input data corresponding to respective ideal simulated location, ideal orientation, and ideal type of a plurality of perception sensors of the autonomous vehicle; determining, via a processor configured to execute instructions stored in a memory, based on the perception sensor input data and the ground-truth information input data, a safety occupancy of at least one obstacle within an area around the autonomous vehicle; and outputting, via the processor, a safety-aware occupancy signal based on the safety occupancy.

### BACKGROUND

Autonomous vehicles (AVs) may require perception of the world in order to make intelligent control decisions. Generally, perception systems are composed of a heterogeneous set of sensors, including, e.g., cameras, ultrasonic/sonar, radar, and LiDAR.

### SUMMARY

An aspect of the present disclosure is drawn to a perception sensor configuration optimization system including: a memory having instructions stored therein; and a processor configured to execute the instructions stored in the memory to cause the perception sensor configuration optimization system to: receive perception sensor input data of an autonomous vehicle, wherein the perception sensor input data corresponds to respective measured location, orientation, and type of a plurality of perception sensors of the autonomous vehicle; receive ground-truth information input data of the autonomous vehicle, wherein the ground-truth information input data corresponds to respective ideal simulated location, ideal orientation, and ideal type of a plurality of perception sensors of the autonomous vehicle; determine, based on the perception sensor input data and the ground-truth information input data, a safety occupancy of at least one obstacle within an area around the autonomous vehicle; and output a safety-aware occupancy signal based on the safety occupancy.

In some embodiments of this aspect, the processor is further configured to execute the instructions stored in the memory to cause the perception sensor configuration optimization system to: determine, based on the perception sensor input data and the ground-truth information input data, a general occupancy of the at least one obstacle within the area around the autonomous vehicle by: splitting a region around the autonomous vehicle into a plurality of voxels; and calculating a respective likelihood of the at least one obstacle occupying each voxel of the plurality of voxels; determine, based on the general occupancy of the at least one obstacle and the safety occupancy of the at least one obstacle, a safety-aware occupancy; and output the safety-aware occupancy signal based on the safety-aware occupancy. In some of these embodiments, the processor is further configured to execute the instructions stored in the memory to cause the perception sensor configuration optimization system to output, to a display, the safety-aware occupancy signal to display a safety-aware occupancy grid illustrating perception coverage around the autonomous vehicle based on the safety-aware occupancy as an array representing the area around the autonomous vehicle. In some of these embodiments, the processor is further configured to execute the instructions stored in the memory to additionally cause the perception sensor configuration optimization system to compare the safety-aware occupancy with benchmark data corresponding to predetermined thresholds of acceptability.

In some embodiments of this aspect, the processor is further configured to execute the instructions stored in the memory to cause the perception sensor configuration optimization system to determine the safety occupancy by: splitting a region around the autonomous vehicle into a plurality of voxels; calculating, for each voxel of the plurality of voxels, a respective likelihood of an obstacle occupation; and establishing constraints to a presence of an obstacle.

In some embodiments of this aspect, the plurality of perception sensors of the autonomous vehicle include a distance perception sensor configured to provide distance information input data of the at least one obstacle, and the processor is further configured to execute the instructions stored in the memory to cause the perception sensor configuration optimization system to determine the safety occupancy by determining, based on the distance information input data and the ground-truth information input data, the safety occupancy of the at least one obstacle within the area around the autonomous vehicle.

In some embodiments of this aspect, the perception sensor configuration optimization system further includes a user interface configured to enable a user to modify the perception sensor input data.

Another aspect of the present disclosure is drawn to a method including: receiving perception sensor input data of an autonomous vehicle, the perception sensor input data corresponding to respective measured location, orientation, and type of each of a plurality of perception sensors of the autonomous vehicle; receiving ground-truth information input data of the autonomous vehicle, the ground-truth information input data corresponding to respective ideal simulated location, ideal orientation, and ideal type of a plurality of perception sensors of the autonomous vehicle; determining, via a processor configured to execute instructions stored in a memory, based on the perception sensor input data and the ground-truth information input data, a safety occupancy of at least one obstacle within an area around the autonomous vehicle; and outputting, via the processor, a safety-aware occupancy signal based on the safety occupancy.

In some embodiments of this aspect, the method further includes: determining, via the processor, based on the perception sensor input data and the ground-truth information input data, a general occupancy of the at least one obstacle within the area around the autonomous vehicle by: splitting, via the processor, a region around the autonomous vehicle into a plurality of voxels; and calculating, via the processor, a respective likelihood of the at least one obstacle occupying each voxel of the plurality of voxels; determining, via the processor, based on the general occupancy of the at least one obstacle and the safety occupancy of the at least one obstacle, a safety-aware occupancy; and outputting, via the processor, the safety-aware occupancy signal based on the safety-aware occupancy. In some of these embodiments, the method further includes displaying, via a display, a safety-aware occupancy grid illustrating perception coverage around the autonomous vehicle based on the safety-aware occupancy as an array representing the area around the autonomous vehicle. In some of these embodiments, the method further includes: receiving, via the processor and from a benchmark system, benchmark data corresponding to predetermined thresholds of acceptability; and comparing, via the processor, the safety-aware occupancy with the benchmark data.

In some embodiments of this aspect, determining the safety occupancy includes: splitting, via the processor, a region around the autonomous vehicle into a plurality of voxels; calculating, via the processor and for each voxel of the plurality of voxels, a respective likelihood of an obstacle occupation; and establishing, via the processor, constraints to a presence of any obstacle.

In some embodiments of this aspect, determining the safety occupancy of obstacles within the area around the autonomous vehicle includes determining, via the processor and based on distance information input data of the at least one obstacle and the ground-truth information input data, the safety occupancy of obstacles within the area around the autonomous vehicle.

In some embodiments of this aspect, the method further includes enabling, via a user interface, a user to modify the perception sensor input data.

Another aspect of the present disclosure is drawn to a non-transitory, computer-readable media having computer-readable instructions stored thereon, which, when executed across one or more processors, causes at least a portion of the one or more processors to perform operations including: receiving perception sensor input data of an autonomous vehicle, the perception sensor input data corresponding to respective measured location, orientation, and type of a plurality of perception sensors of the autonomous vehicle; receiving ground-truth information input data of the autonomous vehicle, the ground-truth information input data corresponding to respective ideal simulated location, ideal orientation, and ideal type of a plurality of perception sensors of the autonomous vehicle; determining, via a processor configured to execute instructions stored in a memory, based on the perception sensor input data and the ground-truth information input data, a safety occupancy of at least one obstacle within an area around the autonomous vehicle; and outputting, via the processor, a safety-aware occupancy signal based on the safety occupancy.

In some embodiments of this aspect, the operations further include: determining, based on the perception sensor input data and the ground-truth information input data, a general occupancy of the at least one obstacle within the area around the autonomous vehicle by: splitting a region around the autonomous vehicle into a plurality of voxels; and calculating a respective likelihood of the at least one obstacle occupying each voxel of the plurality of voxels; determining based on the general occupancy of the at least one obstacle and the safety occupancy of the at least one obstacle, a safety-aware occupancy; and outputting the safety-aware occupancy signal based on the safety-aware occupancy. In some of these embodiments, the operations further include displaying, via a display, a safety-aware occupancy grid illustrating perception coverage around the autonomous vehicle based on the safety-aware occupancy as an array representing the area around the autonomous vehicle.

In some embodiments of this aspect, determining the safety occupancy includes: splitting a region around the autonomous vehicle into a plurality of voxels; calculating, for each voxel of the plurality of voxels, a respective likelihood of an obstacle occupation; and establishing constraints to a presence of an obstacle.

In some embodiments of this aspect, determining the safety occupancy of obstacles within the area around the autonomous vehicle includes determining, via distance information input data of the at least one obstacle and the ground-truth information input data, the safety occupancy of obstacles within the area around the autonomous vehicle.

In some embodiments of this aspect, the operations further include enabling, via a user interface, a user to modify the perception sensor input data.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations

### BRIEF SUMMARY OF THE DRAWINGS

The accompanying drawings, which are incorporated in and form a part of the specification, illustrate and explain examples. In the drawings:

FIG. 1A illustrates an autonomous vehicle with a sensor configuration thereon;

FIG. 1B illustrates the autonomous vehicle with a second sensor configuration thereon;

FIG. 2A-B illustrates an example method for optimization of a perception sensor configuration in accordance with aspects of the present disclosure, wherein FIG. 2A illustrates a first portion of the example method and FIG. 2B illustrates a second portion of the example method;

FIG. 3A illustrates an example perception sensor configuration optimization system in accordance with aspects of the present disclosure at a time t₃;

FIG. 3B illustrates the example perception sensor configuration optimization system of FIG. 3A at a time t₄;

FIG. 3C illustrates the example perception sensor configuration optimization system of FIG. 3A at a time t₅;

FIG. 3D illustrates the example perception sensor configuration optimization system of FIG. 3A at a time t₆;

FIG. 3E illustrates perception sensor configuration optimization system of FIG. 3A at a time t₇;

FIG. 4A illustrates an example of perception sensor configuration optimization system (PCOS) in accordance with aspects of the present disclosure at a time t₃;

FIG. 4B illustrates the example PCOS of FIG. 4B;

FIG. 4C illustrates the example PCOS of FIG. 4C;

FIG. 4D illustrates the example PCOS of FIG. 4D;

FIG. 4E illustrates the example PCOS of FIG. 4A at a time

FIG. 5A illustrates a plan view of an example autonomous vehicle driving through a portion of a city at a time t₀;

FIG. 5B illustrates a plan view of the autonomous vehicle driving through the portion of the city of FIG. 5A at a time t₁.

FIG. 6A illustrates a perspective view of an autonomous vehicle and a scanning of a voxel of FIG. 5A;

FIG. 6B illustrates a perspective view of the autonomous vehicle and a scanning of a voxel of FIG. 5B;

FIG. 7 illustrates a more detailed view of the process of finding safety information-gain;

FIG. 8 illustrates an example safety occupancy grid in accordance with aspects of the present disclosure;

FIG. 9 illustrates an example general occupancy grid in accordance with aspects of the present disclosure; and

FIG. 10 illustrates an example safety-aware occupancy grid in accordance with aspects of the present disclosure.

### DETAILED DESCRIPTION

The perception system that an AV employs is currently configured through trial-and-error; in other words, there is no process for optimizing their configuration given some constraints, e.g., safety/risk assessment capabilities.

Some prior technologies have investigated the optimal LiDAR placement for general perception metrics. Further, different conventional general perception configurations have been reviewed; however, such reviews do not investigate whether these configurations are optimal with respect to a given set of criteria.

Furthermore, some prior systems focus on safety-aware autonomous systems for the purpose of detecting pedestrians. These prior art systems use time-to-collision as a metric for assessing a deep neural network's performance for detecting critical safety scenarios. Finally, a branch of research investigates the assume-guarantee relationships for autonomous system design. This line of research seeks to understand the guarantees a system may provide given assumptions of a scenario's composition. Implicitly, this technology supports a broad range of safety applications through formal verification.

It may be beneficial to have a system and method for optimizing a perception system configuration of an AV given some constraints, e.g., safety/risk assessment capabilities

A system, computer-readable media, and method in accordance with aspects of the present disclosure optimizes a perception system configuration of an AV given some constraints, e.g., safety/risk assessment capabilities.

An example and non-limiting purpose of a system, computer-readable media, and method in accordance with aspects of the present disclosure is to determine (given some risk assessment constraint) the optimal configuration of the sensors of a perception system for providing risk assessment capabilities. A system, computer-readable media, and method in accordance with aspects of the present disclosure was developed with the goal of optimizing the perception of pedestrians and ensuring their safety, but the general procedure is applicable to any autonomous or automated system, such as ground or aerial mobile robots, infrastructure monitoring, etc.

Compared to the systems discussed above, the example and non-limiting problem to be solved is to investigate the optimal perception configuration (i.e., general to all perception sensors) for safety perception metrics. In other words, in accordance with an example and non-limiting aspect of the present disclosure, an optimal perception configuration may be found consisting of all sensors and consisting of configurations that might not be deployed in the world today. A framework in accordance with aspects of the present disclosure also builds on other AV metrics that incorporate safety context of the vehicle. For instance, some conventional research investigates task-aware risk estimation for the purpose of path planning. The objective of this research is to mitigate the impact of perception failures, which is orthogonal to the objective of a system and method in accordance with aspects of the present disclosure. Additionally, this research is not presently compatible with the goal of finding an optimal perception configuration.

Unlike the technologies discussed above, a system and method in accordance with aspects of the present disclosure seeks to do at least two example and non-limiting things differently.

First, in accordance with aspects of the present disclosure, a more general optimization function is used that considers perception configurations that are not on the road today, making a system and method in accordance with aspects of the present disclosure capable of finding optimal sensor configurations that will improve the performance of AVs.

Second, in accordance with aspects of the present disclosure, the scope of a proxy metric is reduced by introducing a maximum information gain of information related to safety-performance.

While other systems also seek to use metrics as a way of assessing safety performance, they do not make use of a proxy metric. The main example and non-limiting advantage of a proxy metric is that it may not require the training of a large machine learning model, and subsequently may not require the computation of various perception (computer vision) model metrics. This is advantageous because, at least in part, doing so is computationally expensive even for just one perception configuration. Being able to iterate over an arbitrary number of configurations and computing the safety performance of each is a tremendous improvement.

As will be described in greater detail below, aspect of the present disclosure presents a high-level algorithm for detecting safety-critical events and then a more specific algorithm that makes use of conditions (i.e., specifications) for which the perception system should optimize.

In an example operation of a system and method in accordance with aspects of the present disclosure includes, first, providing to an optimization function, a set of candidate perception sensors, where they can be located, and how they can be oriented.

In one example embodiment, an optimization function that is solved in accordance with aspects of the present disclosure is shown below; it is formulated as a Binary Integer Program (BIP). A BIP, also known as a zero-one linear program, is a type of mathematical optimization problem where the variables are restricted to be either 0 or 1. This means that the decision variables can only take on two possible values, representing a “yes” or “no” decision. BIPs are a subset of integer programming problems, which are optimization problems where the variables are restricted to being integers. It should be noted that any known optimization procedure may be used that optimizes where a set of candidate perception sensors, where they can be located, and how they can be oriented.

In any event, with the BIP, the information gain of the region around the vehicle, H(V), is maximized and is conditioned on some sensor configuration x. The BIP is constrained by all N sensors being used only once and all M locations sensors can be located within their set capacity cⱼ. The BIP also considers P different orientations that a sensor can be in at each location.

$${max}_{x} {S}_{AMIG} = - H ( V \vert x ) \qquad ( 1 )$$

$$s . t . {\sum }_{j = 1}^{M} {\sum }_{k = 1}^{P} {x}_{i , j , k} \leq 1 ∀ i = 1 , … , N \qquad ( 2 )$$

$${\sum }_{i = 1}^{N} {\sum }_{k = 1}^{P} {x}_{i , j , k} \leq {c}_{j} ∀ j = 1 , … , M \qquad ( 3 )$$

$$wherein {x}_{i , j , k} ∈ \{ 0 , 1 \} ∀ i = 1 , … , Nj = 1 , … , Mk = 1 , … , P$$

Equation 1 is the optimization function. A goal is to maximize the safety-aware information-gain. Equation 2 is the first constraint. Each sensor may only be used at most once (i.e., it may be used or not used). Equation 3 is the second constraint, wherein the number of sensors that occupy a specific location (from j=1, . . . , M) does not exceed the capacity cⱼ.

The scenarios under consideration are simulated and distance information input data of the at least one obstacle from an ego vehicle, the location and distance of other vehicles with respect to the ego vehicle, and information related to the weather is collected as a priori ground truth information input data. The ground truth information input data corresponds to respective ideal simulated location, ideal orientation, and ideal type of a plurality of perception sensors of the autonomous vehicle. It should be noted that other data may be used in accordance with aspects of the present disclosure. In some embodiments, the distance information input data of the at least one obstacle includes at least one of LiDAR, radar, sonar, and camera data.

A simulator output that provides the necessary perception and environment ground truth information input data may be used for verifying the output of a system and method in accordance with aspects of the present disclosure. A non-limiting example of such a simulator includes CARLA, which is an open-source autonomous driving simulator.

Once the ground truth information input data is collected, it can be used to calculate a ground truth safety-related information gain score. Such ground truth information is easily accessible in simulators. It is also possible to engineer scenarios in real-world instrumented driving infrastructure such as Mcity, where there is user control over the data collection process. Mcity is a facility at the University of Michigan and that is purpose-built for testing connected and automated vehicles and technologies under controlled, realistic conditions.

The goal of the optimization function is to find a perception sensor configuration that maximizes the information gain, which is related to the difference between the entropy (uncertainty) of the ground truth perception observations, H(V), and the entropy (uncertainty) generated by a particular configuration H(V|x). H may be calculated by any known method, a non-limiting example of which is disclosed in Hu et al., “Investigating the Impact of Multi-LiDAR Placement on Object Detection for Autonomous Driving,” in Proceedings of the IEEE/CVF Conference on Computer Vision and Pattern Recognition (CVPR), 2022, pp. 2550-2559, the entire disclosure of which is incorporated herein by reference.

H(V) and Ĥ(vᵢ): are defined as:

$$H ( V ) := {\sum }_{{v}_{i} ∈ V} \hat{H} ( {v}_{i} ) \qquad ( 4 )$$

$$\hat{H} ( {v}_{i} ) = - \hat{p} ( {v}_{i} ) log \hat{p} ( {v}_{i} ) - ( 1 - \hat{p} ( {v}_{i} ) ) log ( 1 - \hat{p} ( {v}_{i} ) ) \qquad ( 5 )$$

where vᵢ is a voxel i. and Ĥ(vᵢ) is the information gain of a particular voxel (vᵢ) surrounding the vehicle. The expansion follows information entropy theory, from which the term information-gain is derived. The \hat{p}(vᵢ), described below with reference to equation 6, is the ideal probability that an object will be detected over n frames. For example, if in the ideal world, an object would be detected in 1 out of 5 frames, then there is no expectation to perform better than that in with the real sensors.

A system and method in accordance with aspects of the present disclosure differs from prior art systems in the manner with which \hat{p}(vᵢ) is calculated, which herein is defined as the probability that a given location near the vehicle will have a perception event occur that is of importance to safety. In a system and method in accordance with aspects of the present disclosure, \hat{p}(vᵢ) is calculated using the ground-truth as well as the perception data that is collected for a particular sensor configuration. More specifically, a feature of a system and method in accordance with aspects of the present disclosure, as discussed in greater detail below, includes both how to calculate p (vᵢ) using the ground truth and how to calculate it given some sensor configuration x. During an optimization function process loop, the top-n configurations that are closest to the perfect safety metric score are extracted and further evaluated on more computationally expensive test scenarios. This “top-n” is, left to configured by the system designer to their evaluation needs. During this last step, the goal is to determine which candidate configuration performs the best; the proxy metric is an approximation, so this step allows the designer to verify the candidate configurations using the more robust and computationally expensive methods.

In some embodiments, an optimization loop may terminate based on a predetermined heuristic. In some of these embodiments, the optimization problem itself is a BIP, which is known to be computationally hard to solve. In accordance with aspects of the present disclosure, the predetermined heuristics enable iterating execution and determining when to terminate.

The purpose of a system and method in accordance with aspects of the present disclosure is to provide a framework for finding an optimal perception configuration on an autonomous vehicle for a general purpose (e.g., automated driving, pedestrian safety, vehicle crash prevention). There are two main features in accordance with aspects of the present disclosure: (1) creating a probabilistic occupancy grid based on whether particular perception information meets a defined set of safety specifications; (2) a formalized definition of an optimization problem for perception configuration based on a safety-aware information-gain that is constructed from the probabilistic occupancy grid.

As will be described in greater detail below, the safety-aware information gain for one iteration of the optimization loop is calculated. With one iteration completed, the process can generalize to an arbitrary number of iterations (until the set termination condition). For the non-limiting example proof-of-concept, two safety metrics were chosen to compare: (1) a general occupancy of pedestrians; and (2) a safety occupancy of pedestrians.

In accordance with aspects of the present disclosure, a general occupancy of pedestrians, is calculated by splitting up the region around the vehicle into 3D cubes (i.e., voxels). Then, in each voxel, the likelihood of a pedestrian occupying it is calculated by determining the number of frames in a scene that a pedestrian is occupying the cube over the total number of frames. This is known as the Probabilistic Occupancy Grid (POG).

The mathematical notation for the probability of occupancy of one voxel, p (vᵢ), is:

$$\hat{p} ( {v}_{i} ) = \frac{{Σ}_{j = 1}^{n} 1 ( p ed ∈ {v}_{1 , j} )}{n} \qquad ( 6 )$$

Where 1 (⋅) is the indicator function, vᵢ is the voxel under consideration, there are n frames of data to consider, and vᵢⱼ is the voxel state on frame j.

A safety occupancy of pedestrians is calculated in a comparable manner to the general occupancy. The difference is that there are specifications placed alongside the presence of a pedestrian. A specification is a perception awareness attribute to which a system and method for optimization of vehicle perception configuration in accordance with aspects of the present disclosure must adhere. Some non-limiting examples of specifications include: a pedestrian on the sidewalk being of less critical perception nature than a pedestrian walking on the street; a car cutting through traffic from two lanes on the right behind the autonomous vehicle and in a direction towards the front left of the autonomous vehicle being of higher criticality perception then a car which simply changes lanes; detecting a correct right order of arrival at an intersection; and a vehicle passing a red traffic light as opposed to a vehicle properly stopping the red traffic light.

The non-limiting example specifications discussed above are not about algorithms that detect these events, but rather sensor configuration being able to collect enough data, and pass the collected data to a processor that is configured to executed instructions to cause a system for optimization of vehicle perception configuration in accordance with aspects of the present disclosure to properly classify important safety events.

In some embodiments, the specifications may be explicitly listed such that a processor that is configured to executed instructions to cause a system for optimization of vehicle perception configuration in accordance with aspects of the present disclosure may properly classify important safety events. In some embodiments, data-driven methods and machine learning may be implemented to classify each detection as important or not. Then the optimization would be geared toward detecting critical perception events.

In an example embodiment, it is determined whether the pedestrian is also in the street or if the pedestrian is directly in front of the vehicle. These specifications may be set based on the requirements of the system designer and some dependence may need to be considered for the probability distribution to have valid assumptions regarding independence.

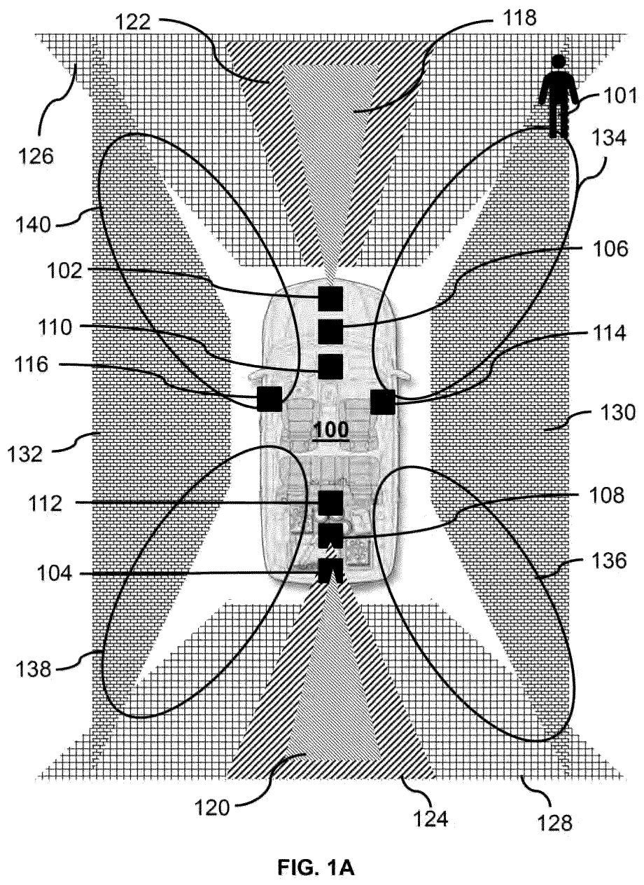

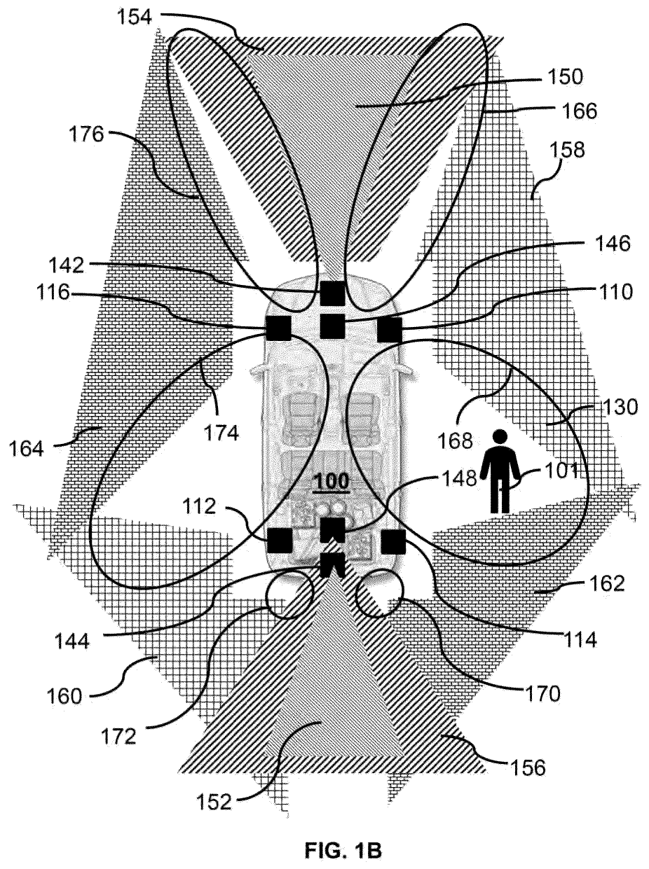

A system and method for optimization of vehicle perception configuration in accordance with aspects of the present disclosure will now be described in greater detail with reference to FIGS. 1A-10.

FIG. 1A illustrates an autonomous vehicle 100 with a sensor configuration thereon.

As shown in the figure, autonomous vehicle 100 includes a forward facing LiDAR 102, a rearward facing LiDAR 104, a forward facing RADAR 106, a rearward facing RADAR 108, a forward facing camera 110, a rearward facing camera 112, a passenger-side facing camera 114, and a driver-side facing camera 116.

Forward facing LiDAR 102 is positioned in the center of the front of autonomous vehicle 100 and has a field of view (FOV as shown by a cone) 118. Rearward facing LiDAR 104 is positioned in the center of the rear of autonomous vehicle 100 and has a FOV as shown by cone 120. Forward facing RADAR 106 is positioned in the center of the front of autonomous vehicle 100 and has a FOV (as shown by a cone) 122. Rearward facing RADAR 108 is positioned in the center of the rear of autonomous vehicle 100 and has a FOV as shown by cone 124. Forward facing camera 110 is positioned in the center of the front of autonomous vehicle 100 and has a FOV (as shown by a cone) 126. Rearward facing camera 112 is positioned in the center of the rear of autonomous vehicle 100 and has a FOV as shown by cone 128. Passenger-side facing camera 114 is positioned in the center of the passenger side of autonomous vehicle 100 and has a FOV (as shown by a cone) 130. Driver-side facing camera 116 is positioned in the center of the driver side of autonomous vehicle 100 and has a FOV as shown by cone 132.

Each of the FOV's discussed above and illustrated in FIG. 1A are not drawn to scale and are merely provided to illustrate that different types of perception sensors, e.g., RADAR, LiDAR, camera, have different FOV's and distances, and further that these different perception sensors may be positioned such that multiple FOV's may overlap in areas around autonomous vehicle 100. For example, in this case, FOV 118 of forward facing LiDAR 102 is wholly overlapped by FOV 122 of forward facing RADAR 106, which is wholly overlapped by FOV 126 of forward facing camera 110.

The purpose of the plurality of perception sensors around autonomous vehicle 100 is to perceive obstacles, e.g., pedestrians, around/near autonomous vehicle 100. In this example, pedestrian 101 may be detected by autonomous vehicle 100 as pedestrian 101 is located within FOV 130 of passenger-side camera 114 and FOV 126 of forward facing camera 110.

However, the location, orientation, and sensor amount, e.g., in this case the FOV and distance, of each perception sensor is a crucial design aspect for autonomous vehicle 100. In particular, for example in this instance, there are areas around and near autonomous vehicle 100 that the plurality of perception sensors cannot perceive, such as for example blind spot areas 134, 136, 138, and 140. This will be further described with reference to FIG. 1B.

FIG. 1B illustrates autonomous vehicle 100 with a second sensor configuration thereon. For autonomous vehicle 100 of FIG. 1B, the sensor configuration is different from that as described above with reference to FIG. 1A.

As shown in FIG. 1B, autonomous vehicle 100 includes a forward facing LiDAR 142, a rearward facing LiDAR 144, a forward facing RADAR 146, a rearward facing RADAR 148, forward facing camera 110, rearward facing camera 112, passenger-side facing camera 114, driver-side facing camera 116.

Forward facing LiDAR 142 is positioned in the center of the front of autonomous vehicle 100 and has a FOV (as shown by a cone) 150. Rearward facing LiDAR 144 is positioned in the center of the rear of autonomous vehicle 100 and has a FOV as shown by cone 152. Forward facing RADAR 146 is positioned in the center of the front of autonomous vehicle 100 and has a FOV (as shown by a cone) 154. Rearward facing RADAR 148 is positioned in the center of the rear of autonomous vehicle 100 and has a FOV as shown by cone 156. Forward facing camera 110 is now positioned in the passenger side front quarter panel of autonomous vehicle 100 and has a FOV as shown by cone 158. Rearward facing camera 112 is now positioned in the driver side rear quarter panel of autonomous vehicle 100 and has a FOV as shown by cone 160. Passenger-side facing camera 114 is positioned in the passenger side rear quarter panel of autonomous vehicle 100 and has a FOV as shown by cone 162. Driver-side facing camera 116 is positioned in the driver side front quarter panel of autonomous vehicle 100 and has a FOV as shown by cone 164.

Each of the FOV's discussed above and illustrated in FIG. 1B are not drawn to scale and are merely provided to illustrate that different types of perception sensors, e.g., RADAR, LiDAR, camera, have different FOV's and distances, and further that these different perception sensors may be positioned such that multiple FOV's may overlap in areas around autonomous vehicle 100. For example, in this case, FOV 150 of forward facing LiDAR 142 is wholly overlapped by FOV 154 of forward facing RADAR 146.

In this example sensor configuration, there are areas around and near autonomous vehicle 100 that the plurality of perception sensors cannot perceive, such as for example blind spot areas 166, 168, 170, 172, 174, and 176.

It should be noted that autonomous vehicle 100 is illustrated as a car, as a non-limiting example provided for discussion purposes. It should be noted that a system and method of perception sensor configuration in accordance with aspects of the present disclosure may be implemented in any type of autonomous vehicle, including aerial and sea-based autonomous vehicles.

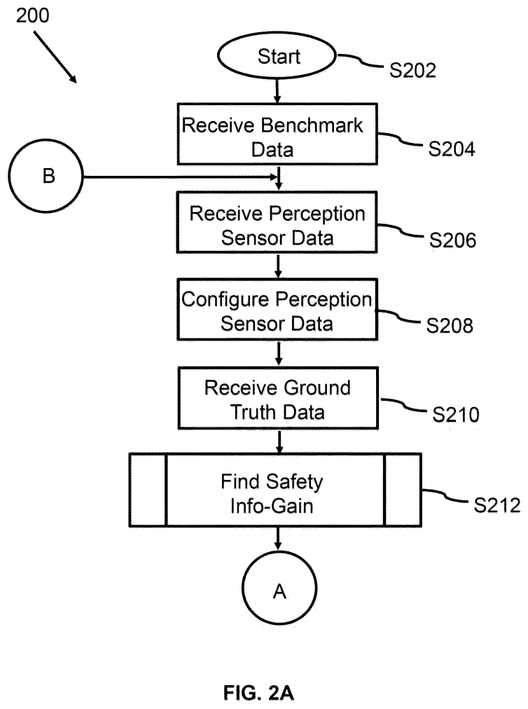

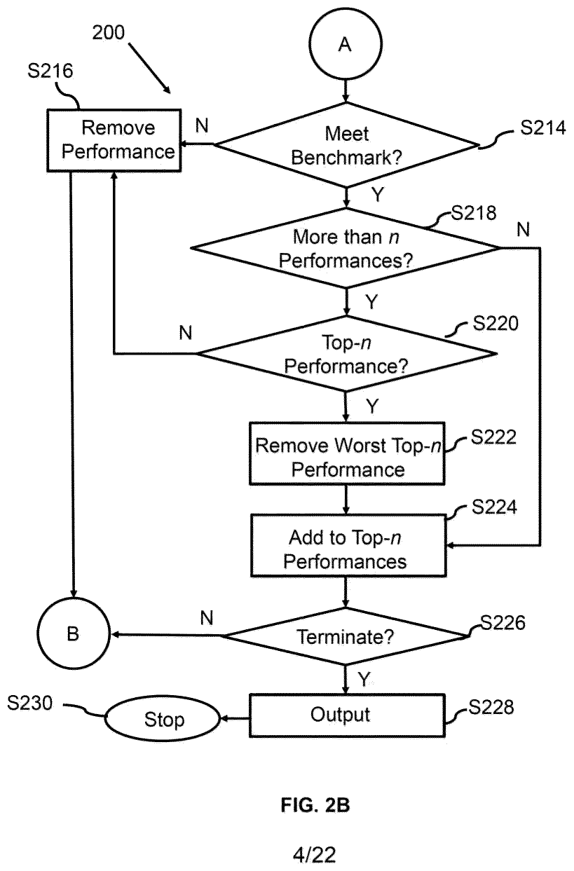

FIG. 2A-B illustrates an example method 200 for optimization of a perception sensor configuration in accordance with aspects of the present disclosure, wherein FIG. 2A illustrates a first portion of method 200 and FIG. 2B illustrates a second portion of method 200.

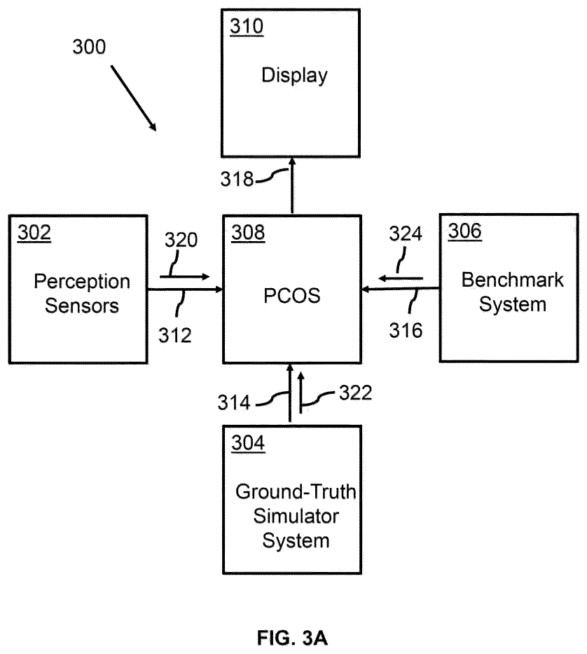

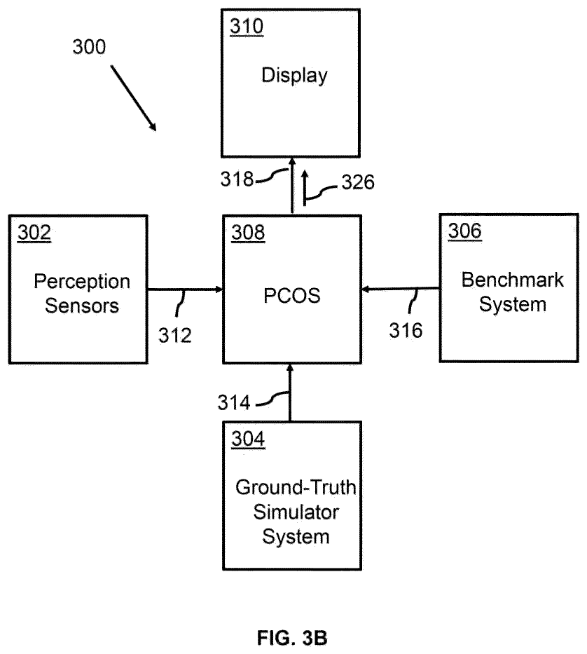

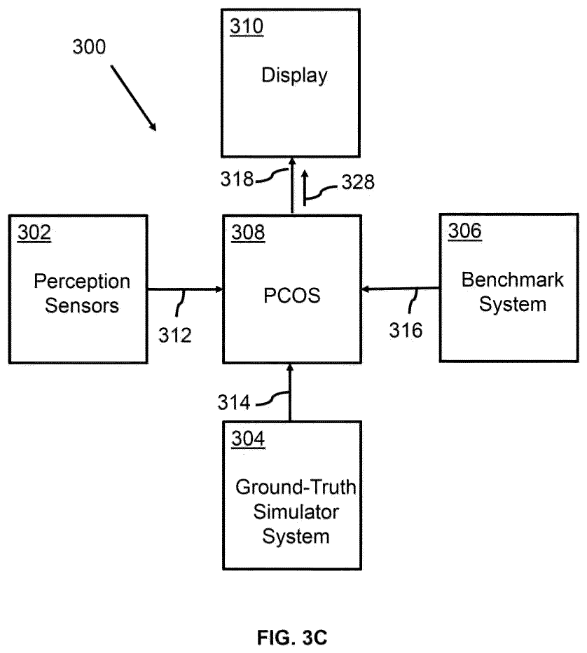

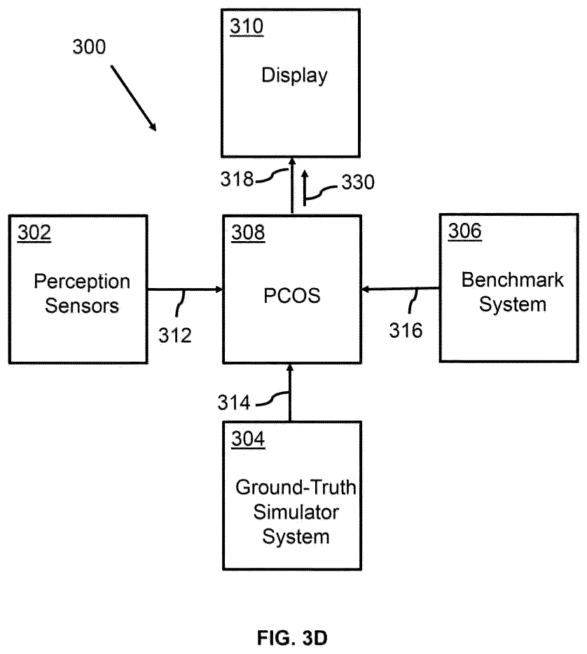

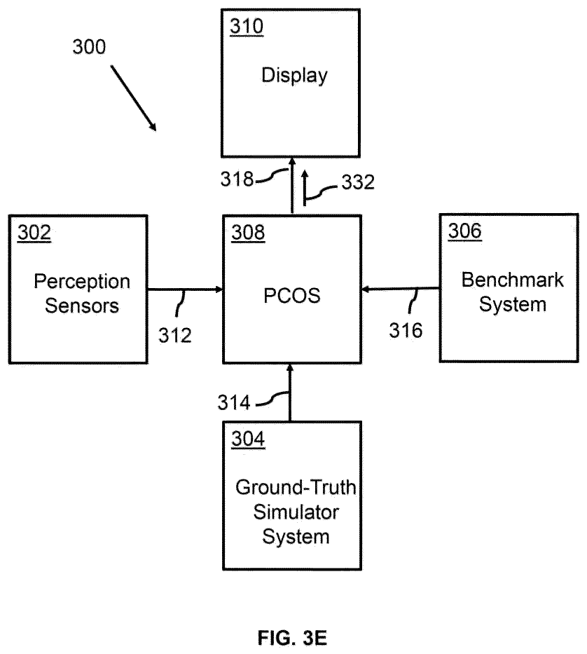

As shown in FIG. 2A, method 200 starts (S202) and benchmark data is received (S204). This will be described in greater detail with reference to FIG. 3A.

FIG. 3A illustrates an example perception sensor configuration optimization system 300 in accordance with aspects of the present disclosure at a time t₃.

As shown in the figure, perception sensor configuration optimization system 300 includes a plurality of perception sensors 302, a ground truth simulator system 304, a benchmark system 306, a perception sensor configuration optimization system (PCOS) 308, and a display 310.

PCOS 308 is configured to: communicate with plurality of perception sensors 302 via a communication channel 312; communicate with ground truth simulator system 304 via a communication channel 314; communicate with benchmark system 306 via a communication channel 316; and communicate with display 310 via a communication channel 318.

In this example, plurality of perception sensors 302, ground truth simulator system 304, benchmark system 306, PCOS 308, and display 310 are illustrated as individual devices. However, in some embodiments, at least two of plurality of perception sensors 302, ground truth simulator system 304, benchmark system 306, PCOS 308, and display 310 may be combined as a unitary device. Further, in some embodiments, at least one of plurality of perception sensors 302, ground truth simulator system 304, benchmark system 306, and PCOS 308 may be implemented as a computer having tangible computer-readable media for carrying or having computer-executable instructions or data structures stored thereon. Such non-transitory computer-readable recording medium refers to any computer program product, apparatus or device, such as a magnetic disk, optical disk, solid-state storage device, memory, programmable logic devices (PLDs), DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to a processor such that the processor may read information from and write information to the tangible computer-readable media. In the alternative, the tangible computer-readable media may be integral to the processor. The processor and the tangible computer-readable media may reside in an integrated circuit (IC), an application specific integrated circuit (ASIC), or large-scale integrated circuit (LSI), system LSI, super LSI, or ultra LSI components that perform a part or all of the functions described herein. In the alternative, the processor and the tangible computer-readable media may reside as discrete components.

Example tangible computer-readable media may also be coupled to systems, non-limiting examples of which include a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

Components of an example computer system/server may include, but are not limited to, one or more processors or processing units, a system memory, and a bus that couples various system components including the system memory to the processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

A program/utility, having a set (at least one) of program modules, may be stored in the memory by way of example, and not limitation, as well as an operating system, one or more application programs, other program modules, and program data. Each of the operating system, one or more application programs, other program modules, and program data or some combination thereof, may include an implementation of a networking environment. The program modules generally carry out the functions and/or methodologies of various embodiments of the application as described herein.

Plurality of perception sensors 302 may include any number of any type of known perception sensors that are configured to perceive the environment within an area and provide distance information input data of obstacles within the area. Non-limiting examples of perception sensors include solid-state LiDAR sensors, mechanical LiDAR sensors, RADAR sensors, ultrasonic sensors, sonar sensors, thermal sensors, and cameras.

Ground truth simulator system 304 may be any known device or system that is configured to simulate, extract scenario data, and generate ground truth information input data 322. In a non-limiting example, CARLA is implemented as ground truth simulator system 304. Ground truth information input data 322 is “perfect” safety information-gain. Ground truth information input data 322 is extracted as the data is generated by ground truth simulator system 304. Ground truth information input data 322 may take the file format as needed or best to represent the data (e.g., spreadsheet, JSON, XML). Perfect detection does not mean the perfect detection only in the FOV. On the contrary, perfect detection may be be all data in the simulation world. What is or is not in the FOV of any particular sensor may be determined by PCOS 308 a later point, as will be described in greater detail below. Ground truth information input data 322 is every piece of relevant information, where acquiring it perfectly could be similar to asking an oracle (a flawless all-knowing thing). In other words, ground truth information input data 322 is not only about objects in the FOV. It should include all objects, so a determination can be made as to whether all objects will be detectable and tractable by the configuration of the plurality of perception sensors 302.

Benchmark system 306 may be any known device or system that is configured to provide benchmark data 324. Benchmark data includes data that may be derived from a known standard, e.g., UL 4600, or some organization, and corresponds to predetermined thresholds of acceptability.

PCOS 308, as will be described in greater detail below, generates a safety occupancy entropy, a general occupancy entropy, and a safety-aware occupancy grid, in accordance with aspects of the present disclosure.

Display 310, as will be described in greater detail below, may be any known device or system that is configured generate to display a safety-aware occupancy grid illustrating perception coverage around the autonomous vehicle based on the safety-aware occupancy.

Communication channels 312, 314, 316, and 318 may be any known type of communication channel, non-limiting examples of which include wired communication channels or wireless communication channels.

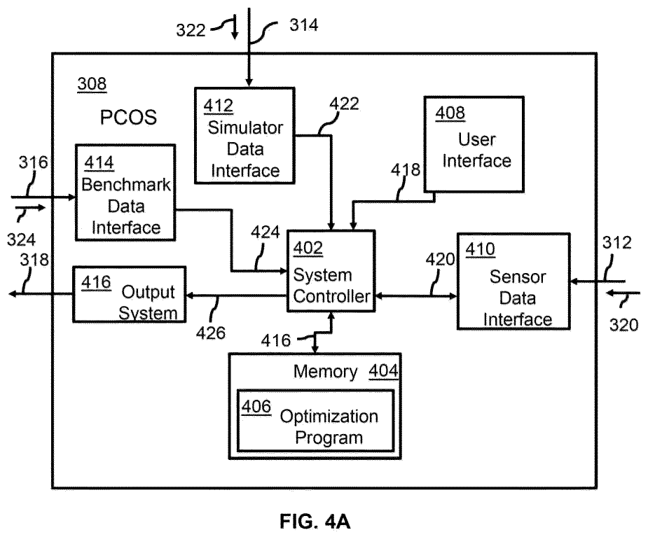

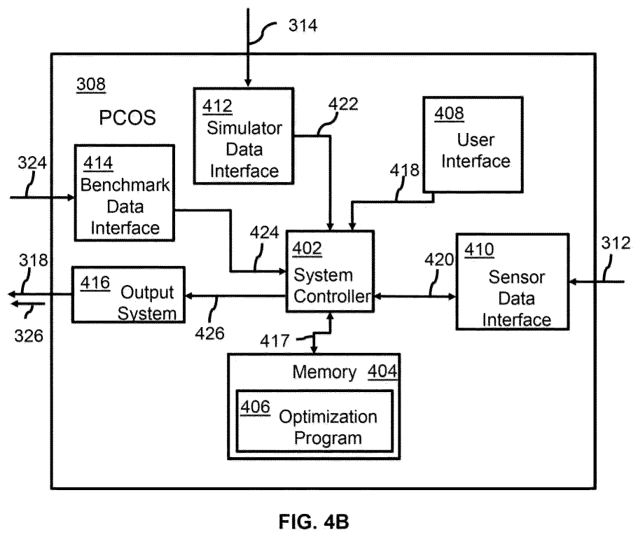

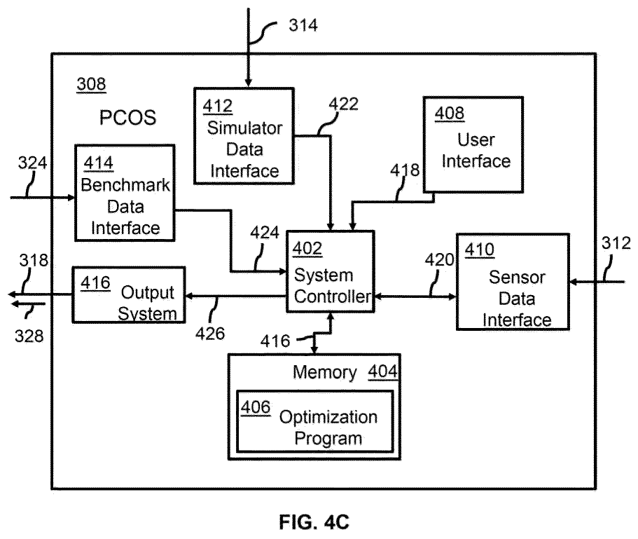

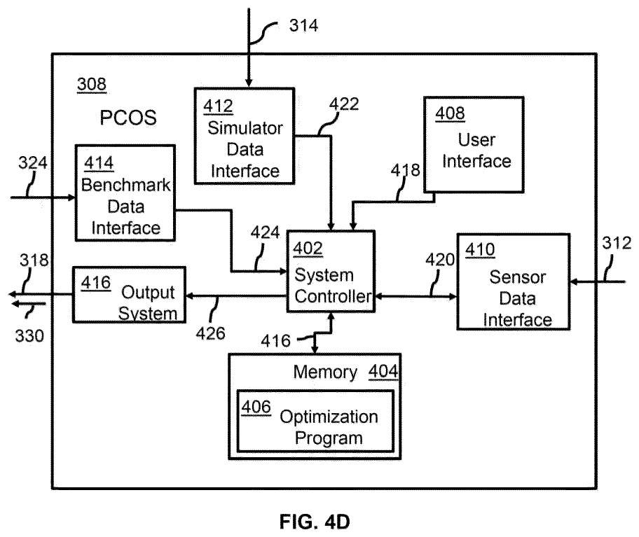

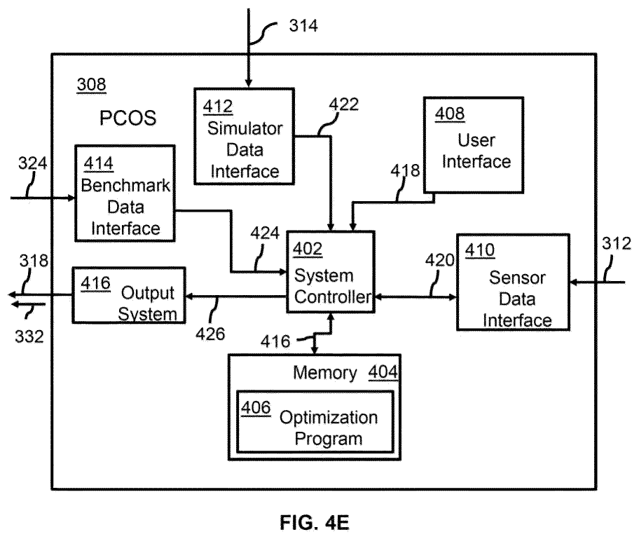

In operation, PCOS 308 receives benchmark data from benchmark system 306. This will be described in greater detail with reference to FIG. 4A.

FIG. 4A illustrates an example of PCOS 308 in accordance with aspects of the present disclosure at a time t₃.

As shown in the figure, PCOS 308 includes a system controller 402, a memory 404 having data, instructions, and an optimization program 406 stored therein, a user interface (UI) 408, a sensor data interface 410, a simulator data interface 412, a benchmark data interface 414, and an output system 416.

System controller 402 is configured to: communicate with memory 404 via a communication channel 417; communicate with UI 408 via a communication channel 418; communicate with sensor data interface 410 via a communication channel 420; communicate with simulator data interface 412 via a communication channel 422; communicate with benchmark data interface 414 via a communication channel 424; and communicate with output system 416 via a communication channel 426.

Sensor data interface 410 is additionally configured to communicate with plurality of perception sensors 302 via communication channel 312.

Simulator data interface 412 is additionally configured to communicate with ground truth simulator system 304 via communication channel 314.

Benchmark data interface 414 is additionally configured to communicate with benchmark system 306 via communication channel 316.

Output system 416 is additionally configured to communicate with display 310 via communication channel 318.

In this example, system controller 402, memory 404, UI 408, sensor data interface 410, simulator data interface 412, benchmark data interface 414, and output system 416 are illustrated as individual devices. However, in some embodiments, at least two of system controller 402, memory 404, UI 408, sensor data interface 410, simulator data interface 412, benchmark data interface 414, and output system 416 may be combined as a unitary device. Further, in some embodiments, at least one of system controller 402, memory 404, UI 408, sensor data interface 410, simulator data interface 412, benchmark data interface 414, and output system 416 may be implemented as a computer having tangible computer-readable media for carrying or having computer-executable instructions or data structures stored thereon.

System controller 402 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of PCOS 308 in accordance with the embodiments described in the present disclosure.

Memory 404, as will be described in greater detail below, has instructions, including optimization program 406, stored therein to be executed by system controller 402 causing PCOS 308 to: determine, based on perception sensor input data 320 and the ground truth information input data 322, a safety occupancy of at least one obstacle within an area around the autonomous vehicle; and output a safety-aware occupancy signal 330 based on the safety occupancy.

In some embodiments, as will be described in greater detail below, optimization program 406 has additional instructions, to be executed by system controller 402, causing PCOS 308 to: determine, based on perception sensor input data 320 and ground truth information input data 322, a general occupancy of the at least one obstacle within the area around the autonomous vehicle by: splitting a region around the autonomous vehicle into a plurality of voxels; and calculating the respective likelihood of at least one respective obstacle occupying each voxel; determine, based on the determined general occupancy of the at least one obstacle and the determined safety occupancy of the at least one obstacle, a safety-aware occupancy; and output the safety-aware occupancy signal 330 based on the determined safety-aware occupancy.

In some embodiments, as will be described in greater detail below, optimization program 406 has additional instructions, to be executed by system controller 402, causing PCOS 308 to: output, to display 310, safety-aware occupancy signal 330 to cause display 310 to display a safety-aware occupancy grid illustrating perception coverage around the autonomous vehicle based on the safety-aware occupancy as an array representing the area around the autonomous vehicle.

In some embodiments, as will be described in greater detail below, optimization program 406 has additional instructions, to be executed by system controller 402, causing PCOS 308 to compare the safety-aware occupancy with benchmark data 324.

In some embodiments, as will be described in greater detail below, optimization program 406 has additional instructions, to be executed by system controller 402, causing PCOS 308 to determine the safety occupancy by: splitting a region around the autonomous vehicle into a plurality of voxels; calculating, for each voxel, the respective likelihood of an obstacle occupation; and establishing constraints to a presence of any obstacle.

Isome embodiments, when the plurality of perception sensors of the autonomous vehicle include a camera, a RADAR and a LiDAR, as will be described in greater detail below, optimization program 406 has additional instructions, to be executed by system controller 402, causing PCOS 308 to determine the safety occupancy by determining, based on camera, RADAR and LiDAR input data and ground truth information input data 322, the safety occupancy of the at least one obstacle within the area around the autonomous vehicle.

In some embodiments, as will be described in greater detail below, optimization program 406 has additional instructions, to be executed by system controller 402, causing PCOS 308 to enable a user to interface with PCOS 308, via UI 408, to cause PCOS 308 to modify the perception sensor input data 320.

UI 408 may be any known device or system that is configured to enable a user to access and control system controller 402. UI 408 may include one or more layers including a human-machine interface (HMI) machines with physical input hardware such a keyboards, mice, game pads and output hardware such as computer monitors, speakers, and printers. Additional UI layers in UI 408 may interact with one or more human senses, including: tactile UI (touch), visual UI (sight), and auditory UI (sound).

In some embodiments, as will be described in greater detail below, UI 408 may be configured to enable a user to interface with PCOS 308 to cause PCOS 308 to modify perception sensor input data 320.

Sensor data interface 410 can include one or more connectors, such as RF connectors, or Ethernet connectors, and/or wireless communication circuitry, such as 5G circuitry and one or more antennas and can operate with corresponding protocols to enable receipt of perception sensor input data 320 from plurality of perception sensors 302.

Simulator data interface 412 can include one or more connectors, such as RF connectors, or Ethernet connectors, and/or wireless communication circuitry, such as 5G circuitry and one or more antennas and can operate with corresponding protocols to enable receipt of ground truth information input data 322 from ground truth simulator system 304.

Benchmark data interface 414 can include one or more connectors, such as RF connectors, or Ethernet connectors, and/or wireless communication circuitry, such as 5G circuitry and one or more antennas and can operate with corresponding protocols to enable receipt of benchmark data 324 from benchmark system 306.

Output system 416 can include one or more connectors, such as RF connectors, or Ethernet connectors, and/or wireless communication circuitry, such as 5G circuitry and one or more antennas and can operate with corresponding protocols to enable output of safety-aware occupancy signal 330 to display 310.

Communication channels 417, 418, 420, 422, 424, and 426 may be any known type of communication channel, non-limiting examples of which include wired communication channels or wireless communication channels.

In operation, benchmark data interface 414 is configured to receive benchmark data 324 from benchmark system 306 via communication channel 316 and provide benchmark data 324 to system controller 402 via communication channel 424. System controller 402 is configured to execute instructions in optimization program 406 to cause system controller 402 to store benchmark data 324 into memory 404 via communication channel 417.

Returning to FIG. 2A, after benchmark data is received (S204), perception sensor data is received (S206). This will be described in greater detail with reference to FIGS. 3A, 4A, 5A-B, and 6A-B.

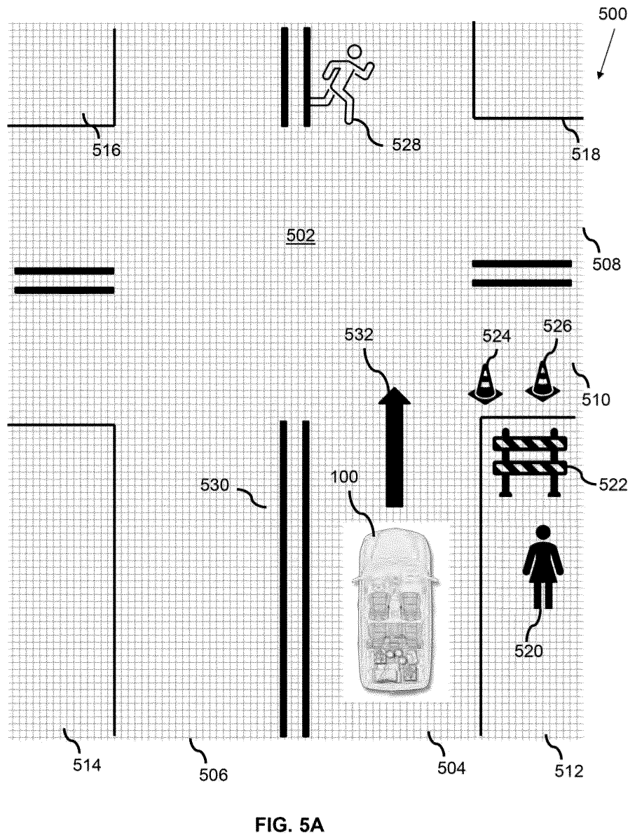

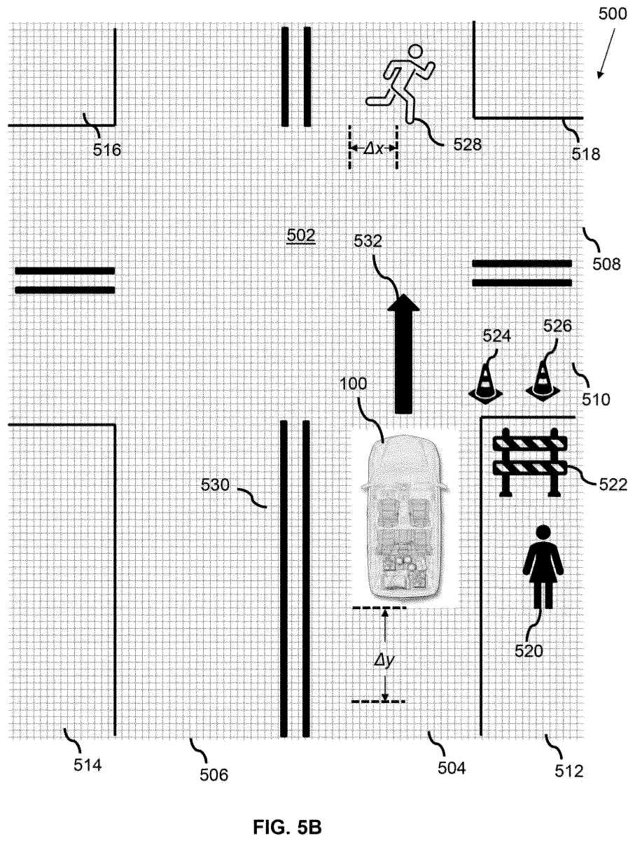

FIG. 5A illustrates a plan view of autonomous vehicle 100 driving through a portion of a city 500 at a time to. As shown in the figure, portion of city 500 includes an intersection 502 of a north-bound lane 504, a south-bound lane 506, a west-bound lane 508, an east-bound lane 510, a sidewalk 512, a sidewalk 514, a sidewalk 516 and a sidewalk 518.

Sidewalk 512 is bounded by north-bound lane 504 and east-bound lane 510. Sidewalk 514 is bounded by south-bound lane 506 and east-bound lane 510. Sidewalk 516 is bounded by south-bound lane 506 and west-bound lane 508. Sidewalk 518 is bounded by north-bound lane 504 and west-bound lane 508.

A plurality of obstacles are strewn around the portion city 500, a sample of which is indicated as a pedestrian 520, a construction sign 522, a construction cone 524, a construction cone 526, and a pedestrian 528.

In operation, autonomous vehicle 100 is driven around the city and the plurality of sensors detect obstacles around autonomous vehicle 100 during the drive. For example, at time to, autonomous vehicle 100 is driving in a north-bound velocity indicated by arrow 532, wherein forward facing LiDAR 102, rearward facing LiDAR 104, forward facing RADAR 106, rearward facing RADAR 108, forward facing camera 110, rearward facing camera 112, passenger-side facing camera 114, and driver-side facing camera 116 will detect obstacles within their respective field of view. More specifically, each detector may detect an obstacle within a voxel in its field of view.

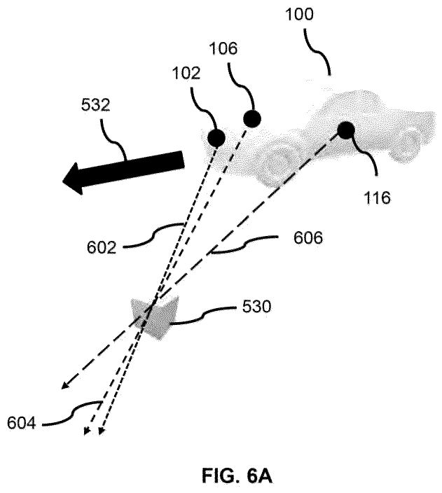

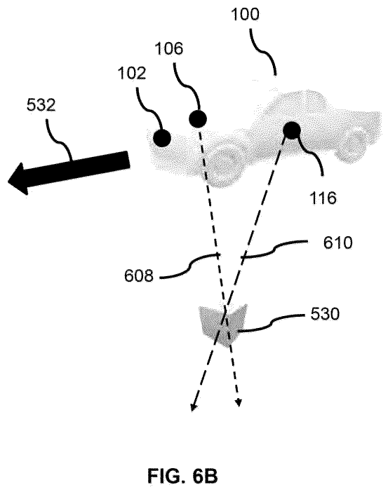

A voxel is a single sample, or data point, on a regularly spaced, three-dimensional (3D) grid. In the plan view of FIG. 5A, the voxels are shown as a grid of 2D pixels, a sample of which is indicated as voxel 530. The scanning of each voxel will be described in greater detail with reference to FIG. 6A.

FIG. 6A illustrates a perspective view of autonomous vehicle 100 and the scanning voxel 530 of FIG. 5A. While the respective fields of view of each of forward facing LiDAR 102, forward facing RADAR 106 and driver-side facing camera 116 are not shown, each detector is able to detect voxel 530. For example, forward facing LiDAR 102 is configured to detect whether voxel 530 includes an obstacle as shown by ray trace 602, forward facing RADAR 106 is configured to detect whether voxel 530 includes an obstacle as shown by ray trace 604, and driver-side facing camera 116 is configured to detect whether voxel 530 includes an obstacle as shown by ray trace 606.

As the number of ray traces increase per voxel, the less uncertainty in determining whether an obstacle is within a voxel. Accordingly, a goal in the sensor suite arrangement is to increase the number of ray traces per voxel. This will be described in greater detail with reference to FIGS. 5B and 6B.

FIG. 5B illustrates a plan view of autonomous vehicle 100 driving through the portion of city 500 at a time t₁. As shown in the figure, autonomous vehicle 100 has moved a distance Δy as compared to its position in FIG. 5A, whereas pedestrian 528 has moved a distance Δx as compared to its position in FIG. 5A.

Forward facing LiDAR 102, rearward facing LiDAR 104, forward facing RADAR 106, rearward facing RADAR 108, forward facing camera 110, rearward facing camera 112, passenger-side facing camera 114, and driver-side facing camera 116 will continue to detect obstacles within their respective field of view.

FIG. 6B illustrates a perspective view of autonomous vehicle 100 and the scanning voxel 530 of FIG. 5B. In this case, voxel 530 is outside of the field of view of forward facing LiDAR 102. Accordingly, as compared with that of FIG. 6A at time t₀, at time t₁, only forward facing RADAR 106 and driver-side facing camera 116 are able to detect voxel 530. In particular, forward facing RADAR 106 is configured to detect whether voxel 530 includes an obstacle as shown by ray trace 608, and driver-side facing camera 116 is configured to detect whether voxel 530 includes an obstacle as shown by ray trace 610.

Autonomous vehicle 100 continues to drive through the city, and the multiple perception sensors continue to accrue sensor data as perception sensor input data 320. When the autonomous vehicle 100 completes the drive, the perception sensor input data 320 is downloaded to PCOS 308. This may be performed by any known method, non-limiting examples of which include wireless and wired transfer of data.

For example, as shown in FIG. 3A, PCOS 308 is configured to receive perception sensor input data 320. This will be described in greater detail with reference to FIG. 4A.

In operation, sensor data interface 410 is configured to receive perception sensor input data 320 from plurality of perception sensors 302 via communication channel 312 and provide perception sensor input data 320 to system controller 402 via communication channel 420. System controller 402 is configured to execute instructions in optimization program 406 to cause system controller 402 to store perception sensor input data 320 into memory 404 via communication channel 417.

Returning to FIG. 2A, after perception sensor data is received (S206), perception sensor data is configured (S208). For example, as shown in FIG. 3A, PCOS 308 is configured to configure perception sensor input data 320. This will be described in greater detail with reference to FIG. 4A.

As shown in FIG. 4A, UI 408 is configured to enable a user to configure perception sensor input data 320. System controller 402 is configured to execute instructions in optimization program 406 to cause system controller 402 to configure the stored perception sensor input data 320 in memory 404 based on the input from the user via UI 408.

For example, a user may interact with UI 408 to input the specific parameters for each perception sensor, non-limiting examples of such parameters include: the measured location on autonomous vehicle 100; the type of perception sensor; the orientation; the field of view; and the detecting distance.

System controller 402 is configured to execute instructions in optimization program 406 to cause system controller 402 to modify perception sensor configuration so as to modify the perception sensor input data 320 to take into account the user supplied parameters for each perception sensor.

Returning to FIG. 2A, after perception sensor data is configured (S208), ground truth data is received (S210). For example, as shown in FIG. 3A, PCOS 308 is configured to receive ground truth information input data 322 from ground truth simulator system 304. This will be described in greater detail with reference to FIG. 4A.

As shown in FIG. 4A, simulator data interface 412 is configured to receive ground truth information input data 322 from ground truth simulator system 304 via communication channel 314 and provide ground truth information input data 322 to system controller 402 via communication channel 422. System controller 402 is configured to execute instructions in optimization program 406 to cause system controller 402 to store ground truth information input data 322 into memory 404 via communication channel 417.

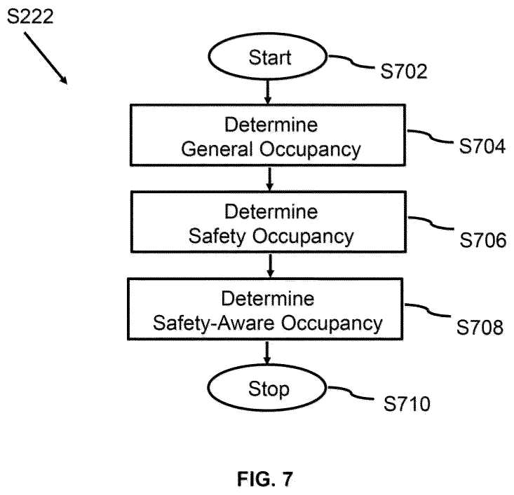

Returning to FIG. 2A, after ground truth data is received (S210), the safety information-gain is found (S212). This will be described in greater detail with reference to FIG. 7.

FIG. 7 illustrates a more detailed view of the process of finding the safety information-gain (S212). As shown in the figure, process S212 starts (S702) and a general occupancy is determined (S704). For example, as shown in FIG. 4A, system controller 402 is configured to execute instructions in optimization program 406 to cause system controller 402 to determine a general occupancy.

In particular, system controller 402 is configured to execute instructions in optimization program 406 to cause system controller 402 to compare the received perception sensor input data 320, that corresponds to what each of plurality of perception sensors 302 detected for each voxel around autonomous vehicle 100 for each frame of time, while autonomous vehicle drove around the city, with the ground truth input information data 322 as provided by ground-truth simulator system 304, in accordance with that as discussed by Hu et al., and with reference to equations (1)-(6) discussed above. From this comparison, system controller 402 is configured to execute instructions in optimization program 406 to cause system controller 402 to generate a general occupancy of at least one obstacle within an area around autonomous vehicle 100.

In some examples, system controller 402 is configured to execute instructions in optimization program 406 to cause system controller 402 to generate a general occupancy as a 3D occupancy grid, for example, as discussed in Hu et al, wherein each voxel in the 3D occupancy grid includes an entropy (uncertainty) value that the voxel will be occupied (by any obstacle) within the next n frames, as discussed above with reference to equation 6. As mentioned above, as autonomous vehicle 100 drives around the city, as the number of ray traces from each of the plurality of perception sensors that pass through each voxel in the 3D occupancy grid increases, the uncertainty that an obstacle may be detected decreases. In other words, the confidence that an obstacle may be detected per voxel in increased.

A 3D occupancy grid may be very complicated for a user to analyze. Therefore, in some embodiments, system controller 402 is configured to execute instructions in optimization program 406 to cause system controller 402 to then generate a general occupancy signal. This will be described in greater detail with reference to FIGS. 3B and 4B.

FIG. 3B illustrates perception sensor configuration optimization system 300 at a time t₄. As shown in the figure, PCOS 308 is configured to store general occupancy data in memory 404 and output a general occupancy signal 326, based on the general occupancy data, to display 310. This will be described in greater detail with reference to FIG. 4B.

FIG. 4B illustrates PCOS 308 at time t₄. As shown in the figure, system controller 402 is configured to execute instructions in optimization program 406 to store general occupancy data in memory 404 and to cause output system 416 to transmit general occupancy signal 326 to display 310. In some embodiments, general occupancy signal 326 will cause display 310 to display an occupancy grid illustrating perception coverage around autonomous vehicle 100 based on the general occupancy.

In some embodiments, general occupancy signal 326 will cause display 310 to display the occupancy grid as an array representing the area around the autonomous vehicle. In some of these embodiments, the array may take the form of a two-dimensional (2D) array of cells representing a 2D area around autonomous vehicle 100. In some embodiments, the array may take the form of a three-dimensional (3D) array of cells representing a 3D area, or volume, around autonomous vehicle 100.

In some embodiments, each cell may be illustrated with a respective numeric value representing a corresponding general occupancy entropy score. In some embodiments, each cell may be illustrated with a respective color representing a corresponding general occupancy entropy score. In some embodiments, each cell may be illustrated with a respective scaled gradient representing a corresponding general occupancy entropy score. In some embodiments, each cell may be represented with a combination of at least one of a respective numeric value, color, and gradient, representing a corresponding general occupancy entropy score.

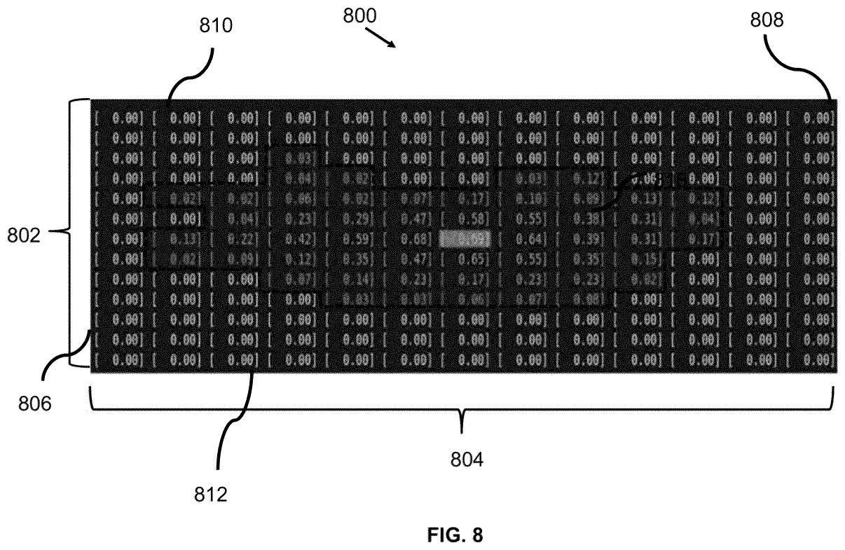

An example embodiment will now be described in greater detail with reference to FIG. 8.

FIG. 8 illustrates an example general occupancy grid 800 in accordance with aspects of the present disclosure.

General occupancy grid 800 represents a flattened version of a 3D occupancy grid mentioned above. General occupancy grid 800 includes a plurality of rows of cells 802 and a plurality of columns of cells 804.

The left-most portion 806 of general occupancy grid 800 corresponds to locations in front of autonomous vehicle 100. The rear-most portion 808 of general occupancy grid 800 corresponds to locations behind autonomous vehicle 100. The top-most portion 810 of general occupancy grid 800 corresponds to locations to the right of autonomous vehicle 100. The bottom-most portion 812 of general occupancy grid 800 corresponds to locations to the left of autonomous vehicle 100.

Each cell contains a corresponding entropy score, which is calculated based on the definition of entropy in information theory, discussed above with reference to equations (1)-(6). For a current arrangement of plurality of perception sensors 302, as shown by general occupancy grid 800, an area 816 surrounding autonomous vehicle 100 has a decreased uncertainty for detecting obstacles-or an increase in confidence in detecting obstacles. Overall, the shape and size of the area surrounding autonomous vehicle 100 that has decreased uncertainty for detecting obstacles is dependent upon the number, type and orientation of the plurality of perception sensors on autonomous vehicle 100.

While determining a general occupancy is known, in accordance with aspects of the present disclosure, the probability that a given location near the vehicle will have a perception event occur that is of importance to safety is also determined. In particular, a safety occupancy is determined. For example, as shown in FIG. 5A, while autonomous vehicle 100 may detect pedestrian 520, the existence of pedestrian 520 may not have an impact on the safety of vehicle 100 as pedestrian 520 is on sidewalk 512 and is not in the traveling path of autonomous vehicle 100. On the contrary, pedestrian 528 is in the traveling path of autonomous vehicle 100. As such, pedestrian 528 may have an impact on the safety of autonomous vehicle 100.

More generally speaking, in accordance with aspects of the present disclosure, additional predetermined constraints may be placed on detected obstacles to determine a safety occupancy. Non-limiting examples of such additional predetermined constraints may include: weather conditions; road conditions; day/night conditions; conditions on location of an obstacle with reference to the autonomous vehicle; conditions on position of an obstacle with reference to the autonomous vehicle; conditions on a velocity of an obstacle with reference to the autonomous vehicle; conditions on a velocity of the autonomous vehicle; and combinations thereof.

Returning to FIG. 7, after the general occupancy is determined (S704), a safety occupancy is determined (S706). This will be described in greater detail with reference to FIGS. 3C and 4C.

FIG. 3C illustrates perception sensor configuration optimization system 300 at a time t₅. As shown in the figure, PCOS 308 is configured to output a safety occupancy signal 328 to display 310. This will be described in greater detail with reference to FIG. 4C.

FIG. 4C illustrates PCOS 308 at time t₅. As shown in the figure, system controller 402 is configured to execute instructions in optimization program 406 to cause system controller 402 to determine a safety occupancy.

In particular, optimization program 406 may have stored therein, predetermined constraints to be placed on detected obstacles to determine a safety occupancy, as noted above. System controller 402 is configured to execute instructions in optimization program 406 to cause system controller 402 to apply the predetermined constraints from optimization program 406 to detected obstacles from received perception sensor input data 320. In an example embodiment, a predetermined constraint is whether an obstacle is pedestrian and is also in the street or if the pedestrian is directly in front of autonomous vehicle 100.

Then in a manner similar to the determination of the general occupancy discussed above (S704), system controller 402 is configured to execute instructions in optimization program 406 to store safety occupancy data in memory 404 and cause system controller 402 to then generate safety occupancy signal 328, based on the safety occupancy data.

Further, system controller 402 is configured to execute instructions in optimization program 406 to cause output system 416 to transmit safety occupancy signal 328 to display 310. In some embodiments, safety occupancy signal 328 will cause display 310 to display a safety occupancy grid illustrating perception coverage around autonomous vehicle 100 based on the safety occupancy. In some embodiments, safety occupancy signal 328 will cause display 310 to display the safety occupancy grid as a 2D array representing the area around the autonomous vehicle. In some embodiments, safety occupancy signal 328 will cause display 310 to display the safety occupancy grid as a 3D array of cells representing a 3D area, or volume, around autonomous vehicle 100.

In some embodiments, each cell may be illustrated with a respective numeric value representing a corresponding safety occupancy entropy score. In some embodiments, each cell may be illustrated with a respective color representing a corresponding safety occupancy entropy score. In some embodiments, each cell may be illustrated with a respective scaled gradient representing a corresponding safety occupancy entropy score. In some embodiments, each cell may be represented with a combination of at least one of a respective numeric value, color, and gradient, representing a corresponding safety occupancy entropy score.

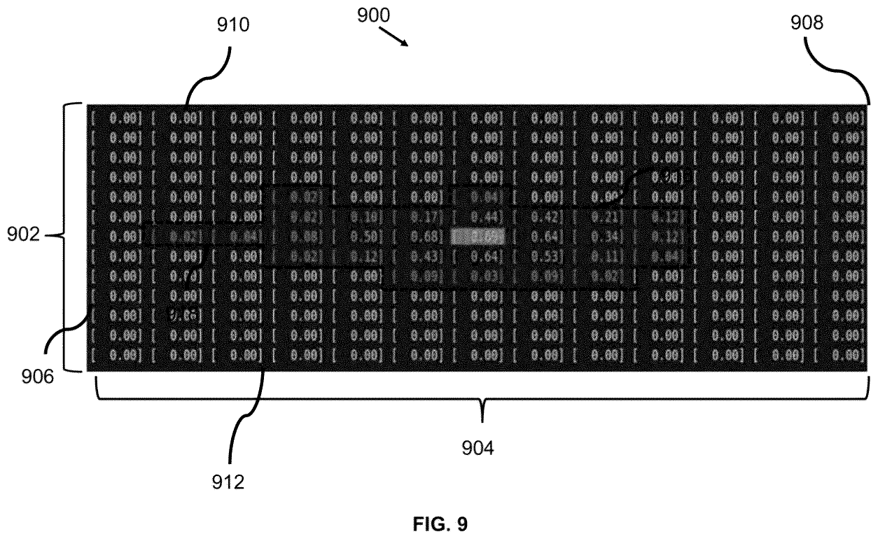

An example embodiment will now be described in greater detail with reference to FIG. 9.

FIG. 9 illustrates an example safety occupancy grid 900 in accordance with aspects of the present disclosure.

Safety occupancy grid 900 represents a flattened version of a 3D safety occupancy grid mentioned above. Safety occupancy grid 900 includes a plurality of rows of cells 902 and a plurality of columns of cells 904.

The left-most portion 906 of safety occupancy grid 900 corresponds to locations in front of autonomous vehicle 100. The rear-most portion 908 of safety occupancy grid 900 corresponds to locations behind autonomous vehicle 100. The top-most portion 910 of safety occupancy grid 900 corresponds to locations to the right of autonomous vehicle 100. The bottom-most portion 912 of safety occupancy grid 900 corresponds to locations to the left of autonomous vehicle 100.

Each cell contains a corresponding entropy score, which is calculated based on the general occupancy grid 800 as modified by the additional predetermined constraints associated with safety occupancy. For a current arrangement of plurality of perception sensors 302, as shown by safety occupancy grid 900, an area 916 surrounding autonomous vehicle 100 has a decreased uncertainty for detecting obstacles—or an increase in confidence in detecting obstacles, that may have an impact on the safety of autonomous vehicle 100. For example, an area 918 of decreased uncertainty may be attributed to pedestrian 528 (as shown for example in FIGS. 5A-B) within the traveling path of autonomous vehicle 100, which may have been detected by each of forward facing LiDAR 102, forward facing RADAR 106 and forward facing camera 110 (as shown in FIG. 1A) over a plurality of frames. In some embodiments a weighting factor may be placed on detected obstacles, wherein obstacles associated with safety occupancy have a higher weighting factor than obstacles that are not associated with safety occupancy.

When comparing general occupancy grid 800 as shown in FIG. 8 with safety occupancy grid 900 as shown in FIG. 9, a general observation is that the overall width of the negative uncertainty cells (cells with higher confidence that an obstacle may be detected) in the safety occupancy grid 900 is much smaller than the general occupancy grid 800. This is a result of the additional predetermined constraints associated with an impact on the safety of autonomous vehicle 100. In short, in this example, there is less concern for safety of autonomous vehicle 100 for obstacles to the right and left of autonomous vehicle 100.

Overall, the shape and size of the area surrounding autonomous vehicle 100 that has decreased uncertainty for detecting obstacles that may have an impact on the safety of autonomous vehicle 100 is dependent upon the number, type and orientation of the plurality of perception sensors on autonomous vehicle 100.

Returning to FIG. 7, after the safety occupancy is determined (S706), a safety-aware occupancy is determined (S708). This will be described in greater detail with reference to FIGS. 3D and 4D.

FIG. 3D illustrates perception sensor configuration optimization system 300 at a time to. As shown in the figure, PCOS 308 is configured to output a safety-aware occupancy signal 330 to display 310. This will be described in greater detail with reference to FIG. 4D.

FIG. 4D illustrates PCOS 308 at time to. As shown in the figure, system controller 402 is configured to execute instructions in optimization program 406 to cause system controller 402 to determine a safety-aware occupancy.

In particular, system controller 402 is configured to execute instructions in optimization program 406 to cause system controller 402 to subtract the uncertainty value for each cell in the general occupancy grid 800 from the uncertainty value for each corresponding cell in the safety occupancy grid 900 to create a safety-aware occupancy grid.

Further, system controller 402 is configured to execute instructions in optimization program 406 to cause output system 416 to transmit safety-aware occupancy signal 332 to display 310. In some embodiments, safety-aware occupancy signal 332 will cause display 310 to display the safety-aware occupancy grid illustrating the information that is gained from the safety occupancy constraints on the perception coverage around autonomous vehicle 100. In some embodiments, safety-aware occupancy signal 332 will cause display 310 to display the safety-aware occupancy grid as a 2D array representing the area around the autonomous vehicle. In some embodiments, safety-aware occupancy signal 332 will cause display 310 to display the safety-aware occupancy grid as a 3D array of cells representing a 3D area, or volume, around autonomous vehicle 100.

In some embodiments, each cell may be illustrated with a respective numeric value representing a corresponding safety-aware occupancy entropy score. In some embodiments, each cell may be illustrated with a respective color representing a corresponding safety-aware occupancy entropy score. In some embodiments, each cell may be illustrated with a respective scaled gradient representing a corresponding safety-aware occupancy entropy score. In some embodiments, each cell may be represented with a combination of at least one of a respective numeric value, color, and gradient, representing a corresponding safety-aware occupancy entropy score.

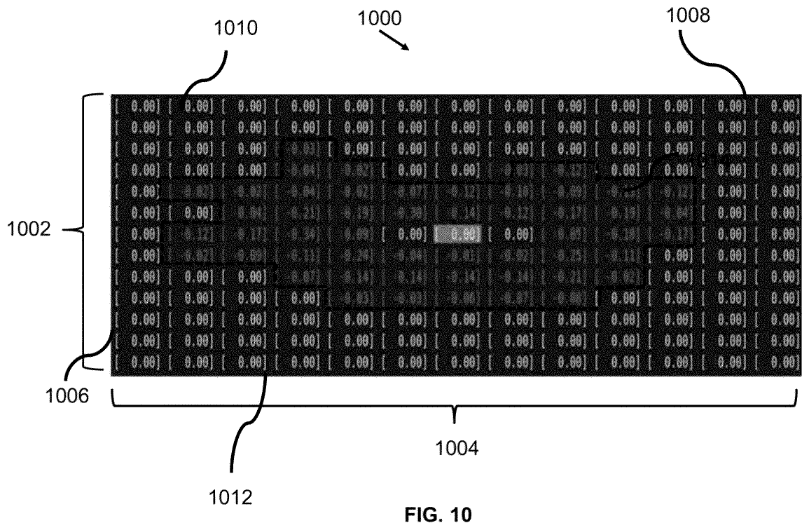

An example embodiment will now be described in greater detail with reference to FIG. 10.

FIG. 10 illustrates an example safety-aware occupancy grid 1000 in accordance with aspects of the present disclosure.

Safety-aware occupancy grid 1000 represents a flattened version of a 3D safety-aware occupancy grid. Safety-aware occupancy grid 1000 includes a plurality of rows of cells 1002 and a plurality of columns of cells 1004.

The left-most portion 1006 of safety-aware occupancy grid 1000 corresponds to locations in front of autonomous vehicle 100. The rear-most portion 1008 of safety-aware occupancy grid 1000 corresponds to locations behind autonomous vehicle 100. The top-most portion 1010 of safety-aware occupancy grid 1000 corresponds to locations to the right of autonomous vehicle 100. The bottom-most portion 1012 of safety-aware occupancy grid 1000 corresponds to locations to the left of autonomous vehicle 100.

Each cell in safety-aware occupancy grid 1000 contains a respective entropy score, which is calculated based on a difference between the entropy score of a corresponding cell in general occupancy grid 800 and the entropy score of a corresponding cell in safety occupancy grid 900.

As a result, a user may easily visualize the total amount of information that is gained from the safety occupancy constraints on the perception coverage around autonomous vehicle 100. Therefore, in accordance with aspects of the present disclosure, a user can easily distinguish which suite of perception sensors provides optimal detection with respect to the safety of the autonomous vehicle. As mentioned above, in accordance with one or more embodiments of the present disclosure, a user may easily visualize the total amount of information that is gained via at least one of a respective numeric value, color, and gradient of the cells in safety-aware occupancy grid 1000. Further, as mentioned above, in some embodiments, a safety-aware occupancy grid may take the form of a 3D grid representing the 3D area, or volume, around autonomous vehicle 100.

Returning to FIG. 7, after the safety-aware occupancy is determined, process S212 stops (S710).

Returning to FIG. 2A, after the safety information-gain is found (S212) as continued on FIG. 2B, it is determined whether the current performance meets predetermined benchmarks (S214). For example, as shown in FIG. 4A, system controller 402 is configured to execute instructions in optimization program 406 to cause system controller 402 to compare the safety-aware occupancy with benchmark data 324 to determine whether the safety-aware occupancy meets predetermined benchmarks.

Benchmark data 324 provide a set of scenarios under which autonomous vehicle 100 should act safely. They are useful for data collection. System controller 402 is configured to execute instructions in optimization program 406 to cause system controller 402 to use benchmark data 324 to create a baseline (the ground truth) and use this to determine whether a particular perception configuration has sufficient coverage of safety-aware information. The various perception configurations use the same baseline as the source of comparison to one another. (e.g., configuration A has higher safety-aware occupancy compared to configuration B when considering information from given benchmark)

Returning to FIG. 2B, if it is determined that the current performance does not meet predetermined benchmarks (N at S214), then the performance is removed (S216). For example, as shown in FIG. 4A, system controller 402 is configured to execute instructions in optimization program 406 to cause system controller 402 to remove perception sensor input data 320, the general occupancy data, the safety occupancy data, and the safety-aware occupancy data from memory 404.

Returning to FIG. 2B, after the performance is removed (S216) then perception sensor data is again configured for another performance (return to S210 as shown in FIG. 2A), and method 200 continues. This process may be performed in a manner as discussed above. Alternatively, if it is determined that the current performance does meets predetermined benchmarks (Y at S214), then it is determined whether there are more than n performances so far (S218). For example, as shown in FIG. 3A, PCOS 308 is configured to determine whether there are n performances so far. This will be described in greater detail with reference to FIG. 4A.

As shown in FIG. 4D, memory 404 may have an integer value, n, stored therein, wherein n represents a predetermined threshold number of configurations of perception sensors to be tested. In some embodiments, system controller 402 is configured to execute instructions in optimization program 406 to enable UI 408 to enable a user to input the integer value for n into memory 404. In some embodiments, system controller 402 is configured to execute instructions in optimization program 406 to enable UI 408 to enable a user to change a currently stored integer value for n in memory 404, to a new integer value n′.

System controller 402 is additionally configured to execute instructions in optimization program 406 to cause system controller 402 to determine how many performances, p, have been performed. This may be performed via any known method, a non-limiting example of which includes an incremental digital counter that increases an integer value of p each time perception sensor input data is configured (S208).

System controller 402 is additionally configured to execute instructions in optimization program 406 to cause system controller 402 to compare a current integer value p with the integer value n stored in memory 404. System controller 402 is additionally configured to execute instructions in optimization program 406 to cause system controller 402 to determine that there are not n performances so far, when p≤n. Further, system controller 402 is additionally configured to execute instructions in optimization program 406 to cause system controller 402 to determine that there are n performances so far, when p>n.

Returning to FIG. 2B, if it is determined that there are n performances so far (Y at S218), then it is determined whether the current performance is a top-n performance (S220). For example, as shown in FIG. 4D, system controller 402 is configured to execute instructions in optimization program 406 to cause system controller 402 to determine whether the current performance is a top-n performance based on predetermined metrics.

In some embodiments, the predetermined metrics for which top-n performances may be ranked are stored in memory 404. In some embodiments, system controller 402 is configured to execute instructions in optimization program 406 to enable UI 408 to enable a user to input the predetermined metrics into memory 404. In some embodiments, system controller 402 is configured to execute instructions in optimization program 406 to enable UI 408 to enable a user to change current predetermined metrics in memory 404 to new predetermined metrics.

In some embodiments, the predetermined metrics include an overall size of the area of unit cells in a safety-aware occupancy grid. In these embodiments, system controller 402 is configured to execute instructions in optimization program 406 to cause system controller 402 to rank the top-n performances based on an overall size of the area of unit cells in a safety-aware occupancy grid that have a negative uncertainty, for example as shown in area 1014 of FIG. 10. In these embodiments, the performances that have the largest overall area of safety-aware detection are valued more.

In some embodiments, the predetermined metrics include an average value of uncertainty of the area of unit cells in a safety-aware occupancy grid. In these embodiments, system controller 402 is configured to execute instructions in optimization program 406 to cause system controller 402 to rank the top-n performances based on an average value of uncertainty of the area of unit cells in a safety-aware occupancy grid that have a negative uncertainty, for example as shown in area 1014 of FIG. 10. In these embodiments, the performances that have the best average safety-aware detection are valued more.

In some embodiments, the predetermined metrics include the area of unit cells in a predetermined position of the area of unit cells in a safety-aware occupancy grid. In these embodiments, system controller 402 is configured to execute instructions in optimization program 406 to cause system controller 402 to rank the top-n performances based on the area of unit cells in a predetermined position in a safety-aware occupancy grid that have a negative uncertainty, for example a left-most portion 1006 of safety-aware occupancy grid 1000 that corresponds to locations in front of autonomous vehicle 100 as shown in area 1014 of FIG. 10. In these embodiments, the performances that have the best safety-aware detection in a particular direction or plural directions are valued more.

In some embodiments, the predetermined metrics include a total sum value of uncertainty of the area of unit cells in a safety-aware occupancy grid. In these embodiments, system controller 402 is configured to execute instructions in optimization program 406 to cause system controller 402 to rank the top-n performances based on a total sum value of uncertainty of the area of unit cells in a safety-aware occupancy grid that have a negative uncertainty, for example as shown in area 1014 of FIG. 10. In these embodiments, the performances that have the most precise safety-aware detection are valued more.

In some embodiments, the predetermined metrics include a total monetary cost of the plurality of perception sensors (e.g., spending $X may result in Y % more safety occupancy score). In these embodiments, system controller 402 is configured to execute instructions in optimization program 406 to cause system controller 402 to rank the top-n performances based on total monetary cost of the plurality of perception sensors. In these embodiments, the performances that have the greatest ratio of occupancy score per total price of sensors are valued more.

In some embodiments, the predetermined metrics include a combination of at least two of the above-discussed predetermined metrics. In these embodiments, system controller 402 is configured to execute instructions in optimization program 406 to cause system controller 402 to rank the top-n performances based on a combination of at least two of: an overall size of the area of unit cells in a safety-aware occupancy grid that have a negative uncertainty; an average value of uncertainty of the area of unit cells in a safety-aware occupancy grid that have a negative uncertainty; the area of unit cells in a predetermined position in a safety-aware occupancy grid that have a negative uncertainty; a total monetary cost of the plurality of perception sensors; and a total sum value of uncertainty of the area of unit cells in a safety-aware occupancy grid that have a negative uncertainty.

In operation, system controller 402 is configured to execute instructions in optimization program 406 to cause system controller 402 to determine whether the safety-aware occupancy grid of the current performance is superior to one of the safety-aware occupancy grid of other top-n performances based on the predetermined metrics discussed above.

Returning to FIG. 2B, if it is determined that the current performance is not a top-n performance (N at S220), then the performance is removed (S216), perception sensor data is again configured for another performance (return to S210 as shown in FIG. 2A), and method 200 continues. This process may be performed in a manner as discussed above.

In other words, autonomous vehicle 100 is outfitted with a plurality of perception sensors, each in a respective location and having a respective orientation on autonomous vehicle 100, and each having a respective field of view and perception capability, for example as shown in FIG. 1A. After the autonomous vehicle 100 is driven around and perception data is captured, in accordance with aspects of the present disclosure: a general occupancy and corresponding general occupancy grid, such as for example as discussed above with reference to FIG. 8, are generated; a safety occupancy and corresponding safety occupancy grid, such as for example as discussed above with reference to FIG. 9, are generated; and a safety-aware occupancy and corresponding safety-aware occupancy grid, such as for example as discussed above with reference to FIG. 10, are generated.

Then a new plurality of perception sensors are mounted on autonomous vehicle 100. This “new” plurality of perception sensors may include at least one of the previously mounted perception sensors, yet having been mounted in at least one of a new location on autonomous vehicle 100 or a new orientation on autonomous vehicle, for example as shown in FIG. 1B. Then again the autonomous vehicle 100 is driven around and new perception data is captured. Then, in accordance with aspects of the present disclosure: a new general occupancy and corresponding new general occupancy grid are generated; a new safety occupancy and corresponding new safety occupancy grid are generated; and a new safety-aware occupancy and corresponding new safety-aware occupancy grid are generated.

Alternatively, if it is determined that the current performance is a top-n performance (Y at S220), then current worst performance of the current top-n performances is removed (S222). For example, as shown in FIG. 3A, PCOS 308 is configured to remove the current worst performance of the current top-n performances. This will be described in greater detail with reference to FIG. 4D.

As shown in FIG. 4D, system controller 402 is configured to execute instructions in optimization program 406 to cause system controller 402 to remove perception sensor input data of the worst performance, the general occupancy data of the worst performance, the safety occupancy data of the worst performance, and the safety-aware occupancy data of the worst performance from memory 404.

Returning to FIG. 2B, after the current worst performance of the current top-n performances is removed (S222), then the current performance is added to the top-n performances (S224). For example, as shown in FIG. 3A, PCOS 308 is configured to add the current performance to the top-n performances. This will be described in greater detail with reference to FIG. 4D.

As shown in FIG. 4A, system controller 402 is configured to execute instructions in optimization program 406 to cause system controller 402 to maintain perception sensor input data of the current performance, the general occupancy data of the current performance, the safety occupancy data of the current performance, and the safety-aware occupancy data of the current performance in memory 404.

Returning to FIG. 2B, alternatively, if it is determined that there are not more than n performances so far (N at S218), then the current performance is added to the top-n performances (S224). This may be performed in a manner as discussed above. After the current performance has been added to the top-n performances (S224), then it is determined whether to terminate performances (S226). For example, as shown in FIG. 3A, PCOS 308 is configured to determine whether to terminate performances. This will be described in greater detail with reference to FIG. 4D.

As shown in FIG. 4D, system controller 402 is configured to execute instructions in optimization program 406 to cause system controller 402 to terminate performances. For example, in some embodiments, criteria for stopping may be stored in memory 404, wherein system controller 402 is configured to execute instructions in optimization program 406 to obtain the stopping criteria from memory 404. Non-limiting examples of stopping criteria include, a predetermined fixed number of performances, a predetermined convergence value, a predetermined time of performing performances, and combinations thereof.

Further, in some embodiments, a user may use UI 408 to input, modify, or change the criteria for stopping in memory 404, wherein system controller 402 is configured to execute instructions in optimization program 406 to, based on input from UI 408, input, modify, or change the criteria for stopping in memory 404.

Returning to FIG. 2B, if it is determined not to terminate performances (N at S226), then perception sensor data is again configured for another performance (return to S210 as shown in FIG. 2A), and method 200 continues. This may be performed in a manner as discussed above. Alternatively, if it is determined to terminate performances (Y at S226), then the performances are outputted (S228). This will be described in greater detail with reference to FIG. 3E.

FIG. 3E illustrates perception sensor configuration optimization system 300 at a time t₇. As shown in the figure, PCOS 308 is configured to output the performances. This will be described in greater detail with reference to FIG. 4E.

FIG. 4E illustrates PCOS 308 at a time t₇. As shown in the figure, system controller 402 is configured to execute instructions in optimization program 406 to cause system controller 402 to cause display 310 to display the top-n safety-aware occupancy grids. In this manner, a user can easily visualize and compare the top-n safety-aware occupancy grids. In particular, a user may easily visually evaluate aspects of the top-n safety-aware occupancy grids with respect to at least one of: an overall area of each grid, thus relating to the overall increased information that is gained from the safety occupancy constraints on the perception coverage around autonomous vehicle 100 for each performance, i.e., each sensor suite arrangement; a particular area of interest of each grid, thus relating to an increased information that is gained from the safety occupancy constraints on the perception coverage around autonomous vehicle 100 for each performance, i.e., each sensor suite arrangement, for a particular area, such as the front of autonomous vehicle 100;. the monetary cost of the sensor configuration; and the return on investment of one sensor configuration over another.

By visualizing the different top-n safety-aware occupancy grids, a user may determine which perception sensor suite arrangement is most beneficial. It should be noted that the “most beneficial” perception sensor suite arrangement might not be the “best” perception sensor suite arrangement based on judging criteria mentioned above. On the contrary, a user may determine that the “best” perception sensor suite arrangement based on judging criteria mentioned above might be too costly to implement via re-tooling a manufacturing line or purchasing the needed perception sensors. In this light, a user may alternatively determine that the “most beneficial” perception sensor suite is not the “best” perception sensor suite arrangement based on judging criteria mentioned above, but in consideration of implementation in a current manufacturing line, the “most beneficial” perception sensor suite is the 5^{th} sensor suite corresponding to the 5^{th} safety-aware occupancy grid of provided the top-n safety-aware occupancy grids.

Returning to FIG. 2B, after the performances are outputted (S228), method 200 stops (S230).

The terminology used herein is for the purpose of describing particular implementations only and is not intended to be limiting of the disclosure. As used herein, the singular forms “a”, “an” and “the” are intended to include the plural forms as well, including any steps performed by a/the computer/processor, unless the context clearly indicates otherwise. As used herein, the phrase “at least one of A, B, and C” should be construed to mean a logical (A OR B OR C), using a non-exclusive logical OR, and should not be construed to mean “at least one of A, at least one of B, and at least one of C.” As another example, the language “at least one of A and B” (and the like) as well as “at least one of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof. Example sizes/models/values/ranges can have been given, although examples are not limited to the same.

The terms (and those similar to) “coupled,” “attached,” “connected,” “adjoining,” “transmitting,” “receiving,” “connected,” “engaged,” “adjacent,” “next to,” “on top of,” “above,” “below,” “abutting,” and “disposed,” used herein is to refer to any type of relationship, direct or indirect, between the components in question, and is to apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action is to occur, either in a direct or indirect manner. The term “set” does not necessarily exclude the empty set-in other words, in some circumstances a “set” may have zero elements. The term “non-empty set” may be used to indicate exclusion of the empty set-that is, a non-empty set must have one or more elements, but this term need not be specifically used. The term “subset” does not necessarily require a proper subset. In other words, a “subset” of a first set may be coextensive with (equal to) the first set. Further, the term “subset” does not necessarily exclude the empty set-in some circumstances a “subset” may have zero elements.

The corresponding structures, materials, acts, and equivalents (e.g., of all means or step plus function elements) that may be in the claims below are intended to include any structure, material, or act for performing the function in combination with other claimed elements as specifically claimed. While the disclosure describes structures corresponding to claimed elements, those elements do not necessarily invoke a means plus function interpretation unless they explicitly use the signifier “means for.” Unless otherwise indicated, recitations of ranges of values are merely intended to serve as a shorthand way of referring individually to each separate value falling within the range, and each separate value is hereby incorporated into the specification as if it were individually recited. While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks. Unless explicitly stated as mutually exclusive, features depicted in different drawings can be combined consistent with the principles of the present disclosure. Moreover, although this disclosure describes and depicts respective implementations herein as including particular components, elements, feature, functions, operations, or steps (and arrangements thereof), any of these implementations may include any combination, arrangement, or permutation of any of the components, elements, features, functions, operations, or steps described or depicted anywhere herein that a person having ordinary skill in the art would comprehend after reading the present disclosure. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

The description of the present disclosure has been presented for purposes of illustration and description but is not intended to be exhaustive or limited to the disclosure in the form disclosed. After reading the present disclosure, many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated. The features of any dependent claim may be combined with the features of any of the independent claims or other dependent claims.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A perception sensor configuration optimization system comprising:
a memory having instructions stored therein; and
a processor configured to execute the instructions stored in said memory to cause said perception sensor configuration optimization system to:
receive perception sensor input data of an autonomous vehicle, wherein the perception sensor input data corresponds to respective measured location, orientation, and type of a plurality of perception sensors of the autonomous vehicle;
receive ground-truth information input data of the autonomous vehicle, wherein the ground-truth information input data corresponds to respective ideal simulated location, ideal orientation, and ideal type of a plurality of perception sensors of the autonomous vehicle;
determine, based on the perception sensor input data and the ground-truth information input data, a safety occupancy of at least one obstacle within an area around the autonomous vehicle; and
output a safety-aware occupancy signal based on the safety occupancy.

2. The perception sensor configuration optimization system of claim 1, wherein said processor is further configured to execute the instructions stored in said memory to cause said perception sensor configuration optimization system to:
determine, based on the perception sensor input data and the ground-truth information input data, a general occupancy of the at least one obstacle within the area around the autonomous vehicle by:
splitting a region around the autonomous vehicle into a plurality of voxels; and
calculating a respective likelihood of the at least one obstacle occupying each voxel of the plurality of voxels;
determine, based on the general occupancy of the at least one obstacle and the safety occupancy of the at least one obstacle, a safety-aware occupancy; and
output the safety-aware occupancy signal based on the safety-aware occupancy.

3. The perception sensor configuration optimization system of claim 2, wherein said processor is further configured to execute the instructions stored in said memory to cause said perception sensor configuration optimization system to output, to a display, the safety-aware occupancy signal to display a safety-aware occupancy grid illustrating perception coverage around the autonomous vehicle based on the safety-aware occupancy as an array representing the area around the autonomous vehicle.

4. The perception sensor configuration optimization system of claim 2, wherein said processor is further configured to execute the instructions stored in said memory to additionally cause said perception sensor configuration optimization system to compare the safety-aware occupancy with benchmark data corresponding to predetermined thresholds of acceptability.

5. The perception sensor configuration optimization system of claim 1, wherein said processor is further configured to execute the instructions stored in said memory to cause said perception sensor configuration optimization system to determine the safety occupancy by:
splitting a region around the autonomous vehicle into a plurality of voxels;
calculating, for each voxel of the plurality of voxels, a respective likelihood of an obstacle occupation; and
establishing constraints to a presence of an obstacle.

6. The perception sensor configuration optimization system of claim 1,
wherein the plurality of perception sensors of the autonomous vehicle include a distance perception sensor configured to provide distance information input data of the at least one obstacle, and
wherein said processor is further configured to execute the instructions stored in said memory to cause said perception sensor configuration optimization system to determine the safety occupancy by determining, based on the distance information input data and the ground-truth information input data, the safety occupancy of the at least one obstacle within the area around the autonomous vehicle.

7. The perception sensor configuration optimization system of claim 1, further comprising a user interface configured to enable a user to modify the perception sensor input data.

8. A method comprising:
receiving perception sensor input data of an autonomous vehicle, the perception sensor input data corresponding to respective measured location, orientation, and type of each of a plurality of perception sensors of the autonomous vehicle;
receiving ground-truth information input data of the autonomous vehicle, the ground-truth information input data corresponding to respective ideal simulated location, ideal orientation, and ideal type of a plurality of perception sensors of the autonomous vehicle;
determining, via a processor configured to execute instructions stored in a memory, based on the perception sensor input data and the ground-truth information input data, a safety occupancy of at least one obstacle within an area around the autonomous vehicle; and
outputting, via the processor, a safety-aware occupancy signal based on the safety occupancy.

9. The method of claim 8, further comprising:
determining, via the processor, based on the perception sensor input data and the ground-truth information input data, a general occupancy of the at least one obstacle within the area around the autonomous vehicle by:
splitting, via the processor, a region around the autonomous vehicle into a plurality of voxels; and
calculating, via the processor, a respective likelihood of the at least one obstacle occupying each voxel of the plurality of voxels;
determining, via the processor, based on the general occupancy of the at least one obstacle and the safety occupancy of the at least one obstacle, a safety-aware occupancy; and
outputting, via the processor, the safety-aware occupancy signal based on the safety-aware occupancy.

10. The method of claim 9, further comprising displaying, via a display, a safety-aware occupancy grid illustrating perception coverage around the autonomous vehicle based on the safety-aware occupancy as an array representing the area around the autonomous vehicle.

11. The method of claim 9, further comprising:
receiving, via the processor and from a benchmark system, benchmark data corresponding to predetermined thresholds of acceptability; and
comparing, via the processor, the safety-aware occupancy with the benchmark data.

12. The method of claim 8, wherein said determining the safety occupancy comprises:
splitting, via the processor, a region around the autonomous vehicle into a plurality of voxels;
calculating, via the processor and for each voxel of the plurality of voxels, a respective likelihood of an obstacle occupation; and
establishing, via the processor, constraints to a presence of an obstacle.

13. The method of claim 8, wherein said determining the safety occupancy of obstacles within the area around the autonomous vehicle comprises determining, via the processor and based on distance information input data of the at least one obstacle and the ground-truth information input data, the safety occupancy of obstacles within the area around the autonomous vehicle.

14. The method of claim 8, further comprising enabling, via a user interface, a user to modify the perception sensor input data.

15. A non-transitory, computer-readable media having computer-readable instructions stored thereon, which, when executed across one or more processors, causes at least a portion of the one or more processors to perform operations comprising:
receiving perception sensor input data of an autonomous vehicle, the perception sensor input data corresponding to respective measured location, orientation, and type of a plurality of perception sensors of the autonomous vehicle;
receiving ground-truth information input data of the autonomous vehicle, the ground-truth information input data corresponding to respective ideal simulated location, ideal orientation, and ideal type of a plurality of perception sensors of the autonomous vehicle;
determining, via a processor configured to execute instructions stored in a memory, based on the perception sensor input data and the ground-truth information input data, a safety occupancy of at least one obstacle within an area around the autonomous vehicle; and
outputting, via the processor, a safety-aware occupancy signal based on the safety occupancy.

16. The non-transitory, computer-readable media of claim 15, wherein the operations further comprise:
determining, based on the perception sensor input data and the ground-truth information input data, a general occupancy of the at least one obstacle within the area around the autonomous vehicle by:
splitting a region around the autonomous vehicle into a plurality of voxels; and
calculating a respective likelihood of the at least one obstacle occupying each voxel of the plurality of voxels;
determining based on the general occupancy of the at least one obstacle and the safety occupancy of the at least one obstacle, a safety-aware occupancy; and
outputting the safety-aware occupancy signal based on the safety-aware occupancy.

17. The non-transitory, computer-readable media claim 16, wherein the operations further comprise displaying, via a display, a safety-aware occupancy grid illustrating perception coverage around the autonomous vehicle based on the safety-aware occupancy as an array representing the area around the autonomous vehicle.

18. The non-transitory, computer-readable media of claim 15, wherein determining the safety occupancy comprises:
splitting a region around the autonomous vehicle into a plurality of voxels;
calculating, for each voxel of the plurality of voxels, a respective likelihood of an obstacle occupation; and
establishing constraints to a presence of an obstacle.

19. The non-transitory, computer-readable media of claim 15, wherein determining the safety occupancy of obstacles within the area around the autonomous vehicle comprises determining, via distance information input data of the at least one obstacle and the ground-truth information input data, the safety occupancy of obstacles within the area around the autonomous vehicle.

20. The non-transitory, computer-readable media of claim 15, wherein the operations further comprise enabling, via a user interface, a user to modify the perception sensor input data.
